(19) United States
(12) Patent Application Publication
(10) Pub. No.: US 2025/0094738 A1
(43) Pub. Date: Mar. 20, 2025

(54) INFORMATION PROCESSING SYSTEM AND INFORMATION PROCESSING METHOD

(71) Applicant: Semiconductor Energy Laboratory Co., Ltd., Atsugi-shi, Kanagawa-ken (JP)

(72) Inventors: Junpei MOMO, Sagamihara (JP); Kana INAHATA, Kyoto (JP); Kunitaka YAMAMOTO, Atsugi (JP)

(21) Appl. No.: 18/825,413

(22) Filed: Sep. 5, 2024

(30) Foreign Application Priority Data
Sep. 15, 2023 (JP) 2023-149985

(51) Int. Cl. G06F 40/58; G06F 40/117

(52) U.S. Cl. CPC G06F 40/58; G06F 40/117

(57) ABSTRACT

An information processing system including a first information processing device and a second information processing device is provided. The first information processing device generates a first processing result including a first translation and a second translation in accordance with a first prompt and transmits the first processing result. The first information processing device generates a second processing result including a third translation and a fourth translation in accordance with a second prompt and transmits the second processing result. The second information processing device is configured to receive a document, metadata, a summary, a first processing result, and a second processing result. The second information processing device is configured to cut a character string with a predetermined length from the beginning of the document.

### BACKGROUND OF THE INVENTION

### 1. Field of the Invention

One embodiment of the present invention relates to an information processing system and an information processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display apparatus, a light-emitting apparatus, a power storage device, a memory device, a method of driving any of them, and a method of manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, a conversational model that gives an answer to a user's prompt can be achieved. In Non-Patent Document 1, generative pre-trained transformer 4 (GPT-4) is disclosed as a large language model, and ChatGPT is disclosed as a conversational model.

By utilizing a large language model, the processing capacity of a natural language processing model is significantly increased. On the other hand, it is difficult to incorporate and operate a language model at one's own facilities and expense due to the expansion of the language model. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the presence of other objects. In one embodiment of the present invention, there is no need to achieve all of these objects. Other objects will be apparent from and can be derived from the description of the specification, the drawings, the claims, and the like.

(1) One embodiment of the present invention is an information processing system including a first information processing device and a second information processing device.

The first information processing device has a function of receiving a first prompt and a function of generating a first processing result in accordance with the first prompt and transmitting the first processing result.

The first information processing device has a function of receiving a second prompt and a function of generating a second processing result in accordance with the second prompt and transmitting the second processing result.

The second information processing device has a function of receiving a document, metadata, and a summary. The metadata includes information related to an attribute of the document.

The second information processing device has a function of cutting a character string with a predetermined length from a beginning of the document and storing the character string in a first block, and a function of cutting a character string with a predetermined length following the first block from the document and storing the character string in a second block.

The second information processing device has a function of generating and transmitting the first prompt. The first prompt includes the first block, the metadata, and the summary, and the summary includes part of the first block. The first prompt includes an instruction to translate the first block to generate a first translation. The first prompt includes an instruction to translate the summary to generate a second translation.

The second information processing device has a function of generating and transmitting the second prompt. The second prompt includes the second translation, the second block, and the metadata. The second prompt includes an instruction to translate the second block by referring to the second translation to generate a third translation. The second prompt includes an instruction to extract part of the second block and to translate the part by referring to the second translation to generate a fourth translation.

The second information processing device has a function of receiving the first processing result and the second processing result. The first processing result includes the first translation and the second translation. The second processing result includes the third translation and the fourth translation.

The second information processing device has a function of extracting the first translation from the first processing result. The second information processing device has a function of extracting the third translation from the second processing result. The second information processing device also has a function of generating a translated document by using the first translation and the third translation.

Thus, the document can be divided into the first block and the second block to be translated. For example, a document which is too long to be written into one prompt can be translated. In addition, the metadata can be used for the translation of the first block. The summary including part of the first block can be prepared in advance and translated into the second translation. The second translation and the metadata can be used for the translation of the second block. Moreover, it is possible to prevent occurrence of a contradiction between the second translation as the translation result of the summary and the third translation as the translation result of the second block. In addition, a translated document with few inconsistencies in translation can be generated. In addition, a translated document with consistency can be generated. As a result, a novel information processing system that is highly convenient, useful, or reliable can be provided.

(2) Another embodiment of the present invention is an information processing system including a first information processing device and a second information processing device.

The first information processing device has a function of receiving a first prompt, and has a function of generating a first processing result in accordance with the first prompt and transmitting the first processing result.

The first information processing device has a function of receiving a second prompt, and has a function of generating a second processing result in accordance with the second prompt and transmitting the second processing result.

The second information processing device has a function of receiving a document and metadata. Note that the metadata includes information related to an attribute of the document.

The second information processing device has a function of cutting a character string with a predetermined length from a beginning of the document and storing the character string in a first block. The second information processing device has a function of cutting a character string with a predetermined length following the first block from the document and storing the character string in a second block.

The second information processing device has a function of generating and transmitting the first prompt. The first prompt includes the first block and the metadata, and the first prompt includes an instruction to translate the first block to generate a first translation. The first prompt includes an instruction to extract part of the first block and to translate the part to generate a second translation.

The second information processing device has a function of generating and transmitting the second prompt. The second prompt includes the second translation, the second block, and the metadata, and the second prompt includes an instruction to translate the second block by referring to the second translation to generate a third translation. The second prompt includes an instruction to extract part of the second block and to translate the part by referring to the second translation to generate a fourth translation.

The second information processing device has a function of receiving the first processing result and the second processing result. Note that the first processing result includes the first translation and the second translation. The second processing result includes the third translation and the fourth translation.

The second information processing device has a function of extracting the first translation from the first processing result, and the second information processing device has a function of extracting the third translation from the second processing result. The second information processing device has a function of generating a translated document by using the first translation and the third translation.

Thus, the document can be divided into the first block and the second block to be translated. For example, a document which is too long to be written into one prompt can be translated. In addition, metadata can be used for the translation of the first block. Furthermore, part of the first block can be extracted and then translated into the second translation. The second translation and metadata can be used for the translation of the second block. Moreover, it is possible to prevent occurrence of a contradiction between the second translation as the translation result of the summary of the first block and the third translation as the translation result of the second block. In addition, a translated document with few inconsistencies in translation can be generated. In addition, a translation document with high consistency can be generated. As a result, a novel information processing system that is highly convenient, useful, or reliable can be provided.

(3) Another embodiment of the present invention is an information processing system including a first information processing device and a second information processing device.

The first information processing device has a function of receiving a first group of prompts in sequence, and a function of generating a first group of processing results in sequence in accordance with the first group of prompts and transmitting the first group of processing results.

The first information processing device has a function of receiving a second group of prompts in sequence, and a function of generating a second group of processing results in sequence in accordance with the second group of prompts and transmitting the second group of processing results.

The second information processing device has a function of receiving a document and metadata. Note that the metadata includes information related to an attribute of the document.

The second information processing device has a function of cutting a character string with a predetermined length from a beginning of the document and storing the character string in a first block. The second information processing device has a function of cutting a character string with a predetermined length following the first block from the document and storing the character string in a second block.

The second information processing device has a function of generating the first group of prompts in sequence and transmitting the first group of prompts. The prompts in the first group each include the first block and the metadata, and an instruction to translate the first block to generate a first translation. The prompts in the first group each include an instruction to extract part of the first block and to translate the part to generate a second translation.

The prompts in the first group each include an instruction to compare the first block and the first translation to generate first correction information, and the first correction information includes a mistranslated expression included in the first translation, the original expression included in the first block of the mistranslated expression, and a proofread expression by correction. The prompts in the first group each include an instruction to compare the first block and the first translation to generate a first proofread translation. The prompts in the first group each include an instruction to compare the first block and the second translation to generate a second proofread translation.

The second information processing device has a function of generating the second group of prompts in sequence and transmitting the second group of prompts. The prompts in the second group each include the second block, the metadata, the second proofread translation, and the first correction information. The prompts in the second group each include an instruction to translate the second block by referring to the second proofread translation and the first correction information to generate a third translation. The prompts in the second group each include an instruction to extract part of the second block and to translate the part by referring to the second proofread translation and the first correction information to generate a fourth translation.

The prompts in the second group each include an instruction to compare the second block and the third translation to generate second correction information, and the second correction information includes a mistranslated expression included in the third translation, the original expression included in the second block of the mistranslated expression, and a proofread expression by correction. The prompts in the second group each include an instruction to compare the second block and the third translation to generate a third proofread translation, and The prompts in the second group each include an instruction to compare the second block and the fourth translation to generate a fourth proofread translation.

The second information processing device has a function of receiving the first group of processing results and the second group of processing results. Note that the first group of processing results includes the first translation, the second translation, the first proofread translation, the second proofread translation, and the first correction information. The second group of processing results includes the third translation, the fourth translation, the third proofread translation, the fourth proofread translation, and the second correction information.

The second information processing device has a function of extracting the first proofread translation from the first group of processing results, and the second information processing device has a function of extracting the third proofread translation from the second group of processing results. The second information processing device has a function of generating a translated document by using the first proofread translation and the third proofread translation.

Thus, the document can be divided into the first block and the second block to be translated. For example, a document which is too long to be written into one prompt can be translated. In addition, the metadata can be used for the translation of the first block. Furthermore, part of the first block can be extracted and then translated into the second translation. The first proofread translation can be generated by comparing the first block and the first translation. The second proofread translation can be generated by comparing the first block and the second translation. The second proofread translation, the first correction information, and the metadata can be used for the translation of the second block. Moreover, it is possible to prevent occurrence of a contradiction between the second proofread translation as the translation result of the summary of the first block and the third proofread translation as the translation result of the second block. In addition, a translated document with few inconsistencies in translation can be generated. In addition, a translation document with high consistency can be generated. As a result, a novel information processing system that is highly convenient, useful, or reliable can be provided.

(4) Another embodiment of the present invention is an information processing method including the following steps.

In a first step, a document that is capable of being divided into a plurality of successive blocks is received.

In a second step, a first prompt including a text of an N-th (N is an integer) block in the document and a first instruction to generate a translation of the text of the N-th block is transmitted to a first information processing device.

In a third step, the translation of the text of the N-th block generated by the first information processing device is received.

In a fourth step, a second prompt including at least part of the translation of the text of the N-th block, a text of an N+1-th block, and a second instruction to generate a translation of the text of the N+1-th block is transmitted to the first information processing device.

(5) Another embodiment of the present invention is the above-described information processing method including the following step.

In the fourth step, the second instruction is to generate the translation of the text of the N+1-th block, with a restriction by at least part of the translation of the text of the N-th block.

(6) Another embodiment of the present invention is an information processing method including first to eighteenth steps.

In the first step, an information terminal receives and transmits a document, metadata, and a summary. In the second step, a first information processing device receives and stores the document, the metadata, and the summary.

In the third step, the first information processing device cuts a character string with a predetermined length from a beginning of the document and stores the character string in a first block. In the fourth step, the first information processing device generates and transmits a first prompt. The first prompt includes the first block, the metadata, and the summary, and the summary includes part of the first block. The first prompt includes an instruction to translate the first block to generate a first translation. The first prompt includes an instruction to translate the summary to generate a second translation.

In the fifth step, a second information processing device receives the first prompt, generates a first processing result in accordance with the first prompt, and transmits the first processing result. The first processing result includes the first translation and the second translation. In the sixth step, the first information processing device receives and stores the first processing result.

In the seventh step, the first information processing device cuts a character string with a predetermined length following the first block from the document and stores the character string in a second block. In the eighth step, the first information processing device generates and transmits a second prompt. The second prompt includes the second translation, the second block, and the metadata. The second prompt includes an instruction to translate the second block by referring to the second translation to generate a third translation. The second prompt includes an instruction to extract part of the second block and to translate the part by referring to the second translation to generate a fourth translation.

In the ninth step, the second information processing device receives the second prompt, generates a second processing result in accordance with the second prompt, and transmits the second processing result. The second processing result includes the third translation and the fourth translation. In the tenth step, the first information processing device receives the second processing result and stores the second processing result following the preceding processing result in sequence.

In the eleventh step, in the case where the last of the document is included in the character string cut by the first information processing device, a last processing result is set as a third processing result, and the process proceeds to the sixteenth step, or in the case where the last of the document is not included in the character string cut by the first information processing device, the process proceeds to the twelfth step until the last of the document is included. The third processing result includes a fifth translation, and the fifth translation includes a translation of the character string that is cut last.

In the twelfth step, the first information processing device cuts a character string with a predetermined length following the preceding third block from the document and stores the character string in a fourth block. In the thirteenth step, the first information processing device generates and transmits a third prompt. The third prompt includes a sixth translation, the fourth block, and the metadata, and the sixth translation includes a translation of part of the preceding third block. The third prompt includes an instruction to translate the fourth block by referring to the sixth translation to generate a seventh translation. The third prompt includes an instruction to extract part of the fourth block and to translate the part by referring to the sixth translation to generate an eighth translation.

In the fourteenth step, the second information processing device receives the third prompt, generates a fourth processing result in accordance with the third prompt, and transmits the fourth processing result. The fourth processing result includes a ninth translation and a tenth translation. In the fifteenth step, the first information processing device receives the fourth processing result and stores the fourth processing result following the preceding processing result in sequence, and the process proceeds to the eleventh step.

In the sixteenth step, the first information processing device extracts the translations in sequence from the processing results stored in sequence, and generates a translated document. The translated document includes the first translation and the fifth translation. In the seventeenth step, the first information processing device transmits the translated document to the information terminal. In the eighteenth step, the information terminal receives and stores the translated document.

Thus, the document can be divided into the first block and the second block to be translated. For example, a document which is too long to be written into one prompt can be translated. In addition, the metadata can be used for the translation of the first block. A summary including part of the first block can be prepared in advance and translated into the second translation. The second translation and the metadata can be used for the translation of the second block. Moreover, it is possible to prevent occurrence of a contradiction between the second translation as the translation result of the summary of the first block and the third translation as the translation result of the second block. In addition, a translated document with few inconsistencies in translation can be generated. In addition, a translation document with high consistency can be generated. As a result, a novel information processing method that is highly convenient, useful, or reliable can be provided.

(7) Another embodiment of the present invention is an information processing method including first to eighteenth steps.

In the first step, an information terminal receives and transmits a document and metadata. In the second step, a first information processing device receives and stores the document and the metadata.

In the third step, the first information processing device cuts a character string with a predetermined length from a beginning of the document and stores the character string in a first block. In the fourth step, the first information processing device generates and transmits a first prompt. The first prompt includes the first block and the metadata, and the first prompt includes an instruction to translate the first block to generate a first translation. The first prompt includes an instruction to extract part of the first block and to translate the part to generate a second translation.

In the fifth step, a second information processing device receives the first prompt, generates a first processing result in accordance with the first prompt, and transmits the first processing result. The first processing result includes the first translation and the second translation. In the sixth step, the first information processing device receives and stores the first processing result.

In the seventh step, the first information processing device cuts a character string with a predetermined length following the first block from the document and stores the character string in a second block. In the eighth step, the first information processing device generates and transmits a second prompt. The second prompt includes the second translation, the second block, and the metadata, and the second prompt includes an instruction to translate the second block by referring to the second translation to generate a third translation. The second prompt includes an instruction to extract part of the second block and to translate the part by referring to the second translation to generate a fourth translation.

In the ninth step, the second information processing device receives the second prompt, generates a second processing result in accordance with the second prompt, and transmits the second processing result. The second processing result includes the third translation and the fourth translation. In the tenth step, the first information processing device receives the second processing result and stores the second processing result following the preceding processing result in sequence.

In the eleventh step, in the case where the last of the document is included in the character string cut by the first information processing device, the last processing result is set as a third processing result, and the process proceeds to the sixteenth step, or in the case where the last of the document is not included in the character string cut by the first information processing device, the process proceeds to the twelfth step until the last of the document is included. The third processing result includes a fifth translation, and the fifth translation includes a translation of the character string that is cut last.

In the twelfth step, the first information processing device cuts a character string with a predetermined length following the preceding third block from the document and stores the character string in a fourth block. In the thirteenth step, the first information processing device generates and transmits a third prompt. The third prompt includes a sixth translation, the fourth block, and the metadata. The third prompt includes an instruction to translate the fourth block by referring to the sixth translation to generate a seventh translation, and the sixth translation includes a translation of part of the preceding third block. The third prompt includes an instruction to extract part of the fourth block and to translate the part by referring to the sixth translation to generate an eighth translation.

In the fourteenth step, the second information processing device receives the third prompt, generates a fourth processing result in accordance with the third prompt, and transmits the fourth processing result. The fourth processing result includes a ninth translation and a tenth translation. In the fifteenth step, the first information processing device receives the fourth processing result and stores the fourth processing result following the preceding processing result in sequence, and the process proceeds to the eleventh step.

In the sixteenth step, the first information processing device extracts the translations in sequence from the processing results stored in sequence, and generates a translated document. The translated document includes the first translation and the fifth translation. In the seventeenth step, the first information processing device transmits the translated document to the information terminal. In the eighteenth step, the information terminal receives and stores the translated document.

Thus, the document can be divided into the first block and the second block to be translated. For example, a document which is too long to be written into one prompt can be translated. In addition, the metadata can be used for the translation of the first block. Furthermore, part of the first block can be extracted and then translated into the second translation. The second translation and the metadata can be used for the translation of the second block. Moreover, it is possible to prevent occurrence of a contradiction between the second translation as the translation result of the summary of the first block and the third translation as the translation result of the second block. In addition, a translated document with few inconsistencies in translation can be generated. In addition, a translation document with high consistency can be generated. As a result, a novel information processing method that is highly convenient, useful, or reliable can be provided.

(8) Another embodiment of the present invention is an information processing method including first to twenty-seventh steps.

In the first step, an information terminal receives and transmits a document and metadata. In the second step, a first information processing device receives and stores the document and the metadata.

In the third step, the first information processing device cuts a character string with a predetermined length from a beginning of the document and stores the character string in a first block. In the fourth step, the first information processing device generates and transmits a first prompt. The first prompt includes the first block and the metadata, and the first prompt includes an instruction to translate the first block to generate a first translation. The first prompt includes an instruction to extract part of the first block and to translate the part to generate a second translation.

In the fifth step, a second information processing device receives the first prompt, generates a first processing result in accordance with the first prompt, and transmits the first processing result. The first processing result includes the first translation and the second translation. In the sixth step, the first information processing device receives and stores the first processing result.

In the seventh step, the first information processing device generates and transmits a second prompt. The second prompt includes an instruction to compare the first block and the first translation to generate first correction information. The first correction information includes a mistranslated expression included in the first translation, the original expression included in the first block of the mistranslated expression, and a proofread expression by correction. The second prompt includes an instruction to compare the first block and the first translation to generate a first proofread translation. The second prompt includes an instruction to compare the first block and the second translation to generate a second proofread translation.

In the eighth step, the second information processing device receives the second prompt, generates a second processing result in accordance with the second prompt, and transmits the second processing result. The second processing result includes the first correction information, the first proofread translation, and the second proofread translation. In the ninth step, the first information processing device receives the second processing result and stores the second processing result following the preceding processing result in sequence.

In the tenth step, the first information processing device cuts a character string with a predetermined length following the first block from the document and stores the character string in a second block. In the eleventh step, the first information processing device generates and transmits a third prompt. The third prompt includes the second proofread translation, the second block, and the metadata. The third prompt includes an instruction to translate the second block by referring to the second proofread translation to generate a third translation. The third prompt includes an instruction to extract part of the second block and to translate the part by referring to the second proofread translation to generate a fourth translation.

In the twelfth step, the second information processing device receives the third prompt, generates and transmits a third processing result in accordance with the third prompt, and transmits the third processing result. The third processing result includes the third translation and the fourth translation. In the thirteenth step, the first information processing device receives the third processing result and stores the third processing result following the preceding processing result in sequence.

In the fourteenth step, the first information processing device generates and transmits a fourth prompt. The fourth prompt includes an instruction to compare the second block and the third translation to generate second correction information. The second correction information includes a mistranslated expression included in the third translation, the original expression included in the second block of the mistranslated expression, and a proofread expression by correction. The fourth prompt includes an instruction to compare the second block and the third translation to generate a third proofread translation. The fourth prompt includes an instruction to compare the second block and the fourth translation to generate a fourth proofread translation.

In the fifteenth step, the second information processing device receives the fourth prompt, generates a fourth processing result in accordance with the fourth prompt, and transmits the fourth processing result. The fourth processing result includes the second correction information, the third proofread translation, and the fourth proofread translation. In the sixteenth step, the first information processing device receives the fourth processing result and stores the fourth processing result following the preceding processing result in sequence.

In the seventeenth step, in the case where the last of the document is included in the character string cut by the first information processing device, the last processing result is set as a fifth processing result, and the process proceeds to the twenty-fifth step, or in the case where the last of the document is not included in the character string cut by the first information processing device, the process proceeds to the eighteenth step until the last of the document is included. The fifth processing result includes a fifth proofread translation, and the fifth proofread translation includes a translation of the character string that is cut last.

In the eighteenth step, the first information processing device cuts a character string with a predetermined length following the preceding third block from the document and stores the character string in a fourth block. In the nineteenth step, the first information processing device generates and transmits a fifth prompt. The fifth prompt includes a sixth proofread translation, the fourth block, and the metadata, and the sixth proofread translation includes a translation of part of the preceding third block. The fifth prompt includes an instruction to translate the fourth block by referring to the sixth proofread translation to generate a fifth translation. The fifth prompt includes an instruction to extract part of the fourth block and to translate the part by referring to the sixth proofread translation to generate a sixth translation.

In the twentieth step, the second information processing device receives the fifth prompt, generates a sixth processing result in accordance with the fifth prompt, and transmits the sixth processing result. The sixth processing result includes a seventh translation and an eighth translation. In the twenty-first step, the first information processing device receives the sixth processing result and stores the sixth processing result following the preceding processing result in sequence.

In the twenty-second step, the first information processing device generates and transmits a sixth prompt. The sixth prompt includes an instruction to compare the fourth block and the fifth translation to generate third correction information. The third correction information includes a mistranslated expression included in the seventh translation, the original expression included in the fourth block of the mistranslated expression, and a proofread expression by correction. The sixth prompt includes an instruction to compare the third block and the seventh translation to generate a seventh proofread translation. The sixth prompt includes an instruction to compare the fourth block and the eighth translation to generate an eighth proofread translation.

In the twenty-third step, the second information processing device receives the sixth prompt, generates a seventh processing result in accordance with the sixth prompt, and transmits the seventh processing result. The seventh processing result includes the third correction information, the seventh proofread translation, and the eighth proofread translation. In the twenty-fourth step, the first information processing device receives the seventh processing result and stores the seventh processing result following the preceding processing result in sequence, and the process proceeds to the seventeenth step.

In the twenty-fifth step, the first information processing device extracts the proofread translations in sequence from the processing results stored in sequence, and generates a translated document. The translated document includes the first proofread translation and the fifth proofread translation. In the twenty-sixth step, the first information processing device transmits the translated document to the information terminal. In the twenty-seventh step, the information terminal receives and stores the translated document.

Thus, the document can be divided into the first block and the second block to be translated. For example, a document which is too long to be written into one prompt can be translated. In addition, the metadata can be used for the translation of the first block. Furthermore, part of the first block can be extracted and then translated into the second translation. The first proofread translation can be generated by comparing the first block and the first translation. The second proofread translation can be generated by comparing the first block and the second translation. The first proofread translation, the second proofread translation, the first correction information, and the metadata can be used for the translation of the second block. Moreover, it is possible to prevent occurrence of a contradiction between the first proofread translation as the translation result of the first block and the third proofread translation as the translation result of the second block. In addition, a translated document with few inconsistencies in translation can be generated. In addition, a translation document with high consistency can be generated. As a result, a novel information processing method that is highly convenient, useful, or reliable can be provided.

Although the block diagrams in drawings attached to this specification show components classified by their functions as independent blocks, it is difficult to classify actual components based on their functions completely, and one component can have a plurality of functions.

One embodiment of the present invention can provide a novel information processing system that is highly convenient, useful, or reliable. Another embodiment of the present invention can provide a novel information processing method that is highly convenient, useful, or reliable. In addition, a novel information processing system can be provided. Furthermore, a novel information processing method can be provided.

Note that the description of these effects does not preclude the presence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of an information processing system of an embodiment;

FIG. 2 illustrates a structure of an information processing device of an embodiment;

FIGS. 3A to 3C illustrate a structure of a document and a translated document of an embodiment;

FIG. 4 illustrates structures of prompts and processing results of an embodiment;

FIG. 5 illustrates structures of prompts and processing results of an embodiment;

FIG. 6 illustrates structures of prompts and processing results of an embodiment;

FIG. 7 illustrates an information processing method of an embodiment; and

FIG. 8 illustrates an information processing method of an embodiment.

### DETAILED DESCRIPTION OF THE INVENTION

An information processing system of one embodiment of the present invention includes a first information processing device and a second information processing device. The first information processing device has a function of receiving a first prompt, and a function of generating a first processing result in accordance with the first prompt and transmitting the first processing result. The first information processing device has a function of receiving a second prompt, and a function of generating a second processing result in accordance with the second prompt and transmitting the second processing result.

The second information processing device has a function of receiving a document, metadata, and a summary, and the metadata includes information related to an attribute of the document. The second information processing device has a function of cutting a character string with a predetermined length from the beginning of the document and storing the character string in a first block. The second information processing device has a function of cutting a character string with a predetermined length following the first block from the document and storing the character string in a second block. The second information processing device has a function of generating and transmitting the first prompt. Note that the first prompt includes the first block, the metadata, and the summary, and the summary includes part of the first block. The first prompt includes an instruction to translate the first block to generate a first translation, and an instruction to translate the summary to generate a second translation. The second information processing device has a function of generating and transmitting the second prompt. Note that the second prompt includes the second translation, the second block, and the metadata; the second prompt includes an instruction to translate the second block by referring to the second translation to generate a third translation; and the second prompt includes an instruction to extract part of the second block and to translate the part by referring to the second translation to generate a fourth translation.

The second information processing device has a function of receiving the first processing result and the second processing result. Note that the first processing result includes the first translation and the second translation. Note that the second processing result includes the third translation and the fourth translation. The second information processing device has a function of extracting the first translation from the first processing result, a function of extracting the third translation from the second processing result, and a function of generating a translated document by using the first translation and the third translation.

Thus, the document can be divided into the first block and the second block to be translated. For example, a document which is too long to be written into one prompt can be translated. In addition, the metadata can be used for the translation of the first block. The summary including part of the first block can be prepared in advance and translated into the second translation. The second translation and the metadata can be used for the translation of the second block. Moreover, it is possible to prevent occurrence of a contradiction between the second translation as the translation result of the summary and the third translation as the translation result of the second block. In addition, a translated document with few inconsistencies in translation can be generated. In addition, a translated document with consistency can be generated. As a result, a novel information processing system that is highly convenient, useful, or reliable can be provided.

Embodiments will be described in detail with reference to the drawings. Note that the embodiments of the present invention are not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

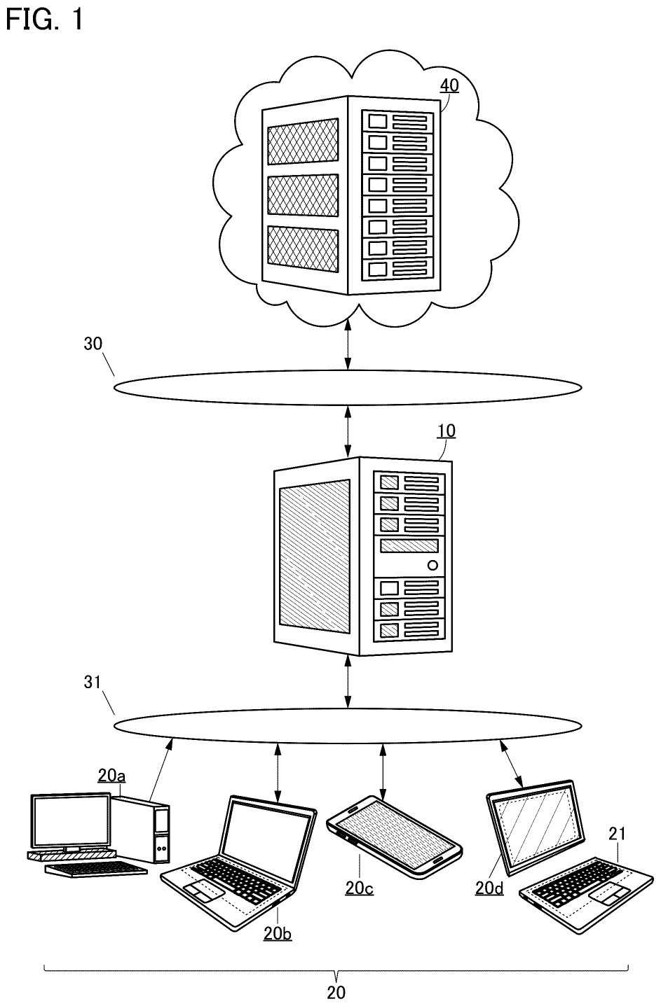

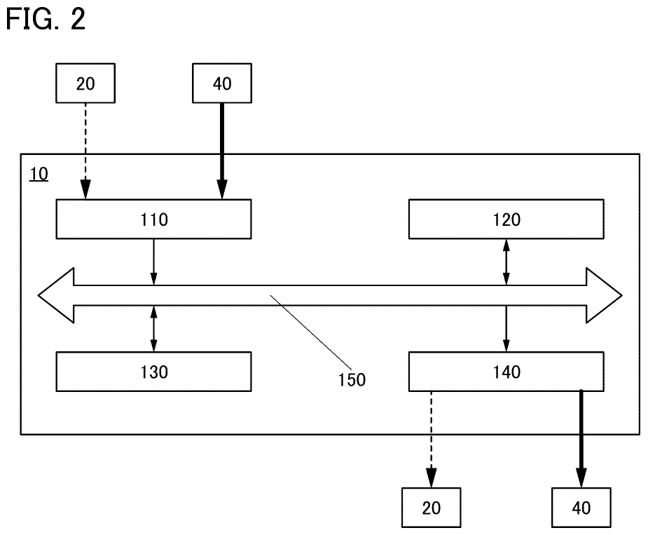

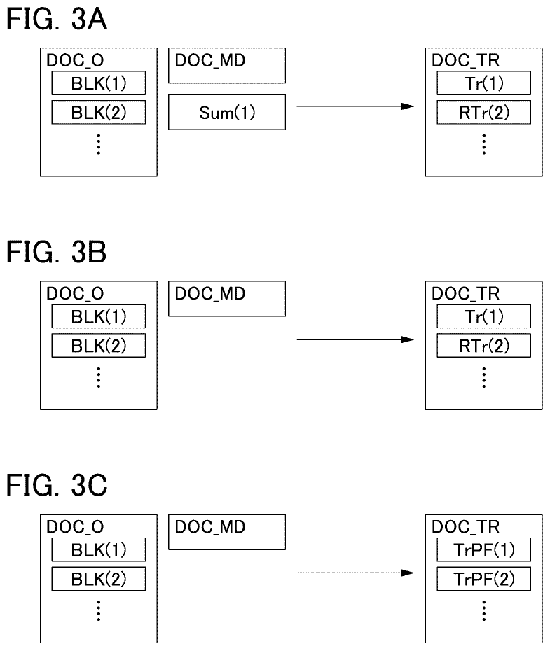

In this embodiment, a structure of an information processing system of one embodiment of the present invention is described with reference to FIG. 1, FIG. 2, FIGS. 3A to 3C, FIG. 4, and FIG. 5.

FIG. 1 illustrates a structure of an information processing system of one embodiment of the present invention.

FIG. 2 is a block diagram illustrating a structure of an information processing device that can be used in the information processing system of one embodiment of the present invention.

FIG. 3A is a diagram illustrating structures of a document and a translated document that can be handled by the information processing system of one embodiment of the present invention, FIG. 3B is a diagram illustrating structures of a document and a translated document that are different from those in FIG. 3A, and FIG. 3C is a diagram illustrating structures of a document and a translated document that are different from those in FIGS. 3A and 3B.

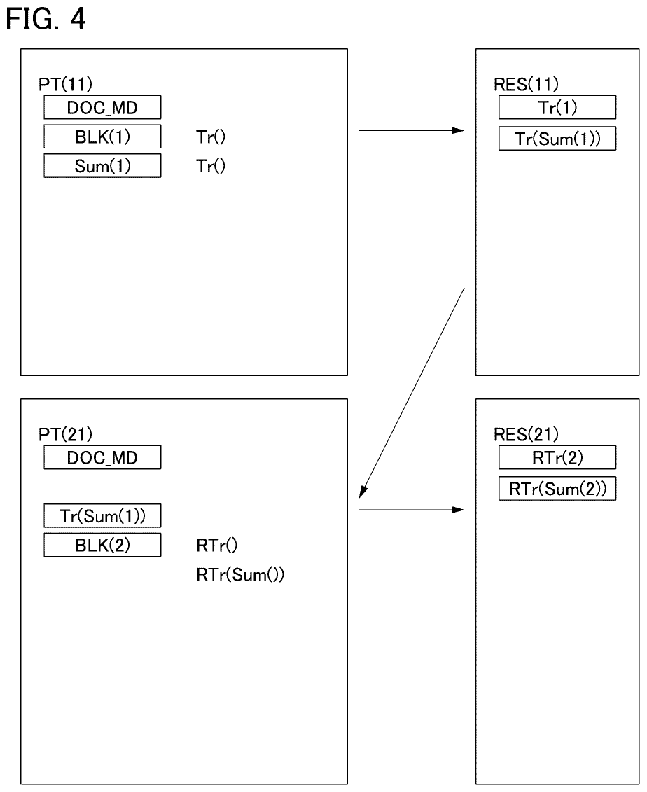

FIG. 4 is a diagram illustrating structures of a prompt and a processing result that are transmitted and received in the information processing system of one embodiment of the present invention.

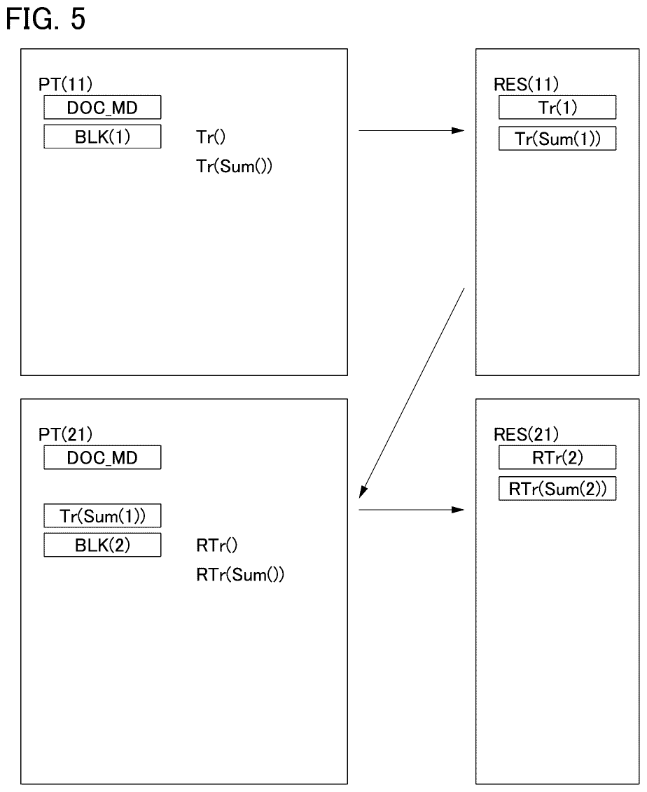

FIG. 5 is a diagram illustrating structures of a prompt and a processing result that are transmitted and received in the information processing system of one embodiment of the present invention, which are different from those in FIG. 4.

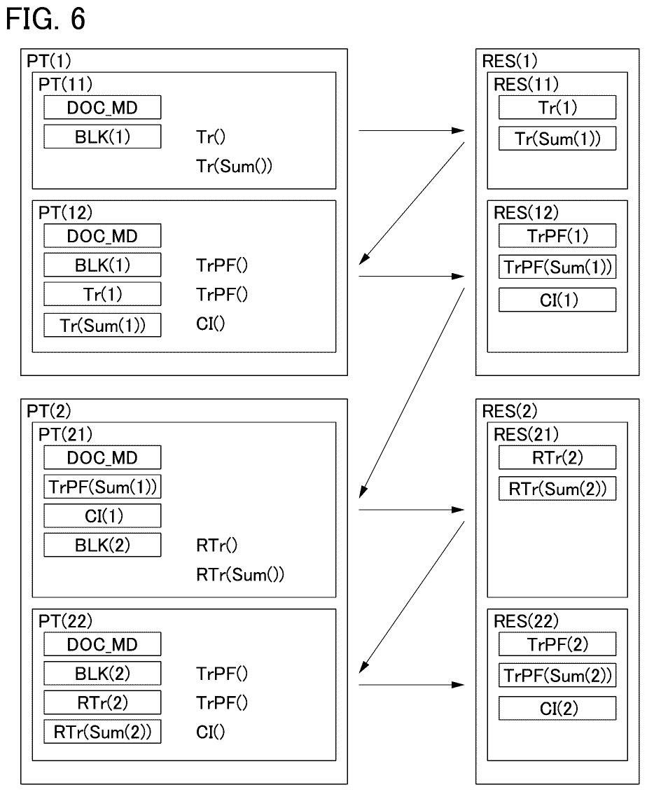

FIG. 6 is a diagram illustrating structures of a prompt and a processing result that are transmitted and received in the information processing system of one embodiment of the present invention, which are different from those in FIG. 4 and FIG. 5.

### Structure Example 1 of Information Processing System

The information processing system described in this embodiment includes an information processing device 40 and an information processing device 10 (see FIG. 1). The information processing system also includes an information terminal 20.

### Structure Example 1 of Information Processing Device 40

The information processing device 40 has a function of receiving a prompt PT(11). The information processing device 40 has a function of generating a processing result RES(11) in accordance with the prompt PT(11) and transmitting the processing result RES(11). For example, the information processing device 40 can transmit the processing result RES(11) to the information processing device 10 via a network 30 (see FIG. 1).

The information processing device 40 has a function of receiving a prompt PT(21). The information processing device 40 has a function of executing processing using a large language model and a function of generating a processing result RES(21) in accordance with the prompt PT(21) and transmitting the processing result RES(21).

### Structure Example 1 of Information Processing Device 10

The information processing device 10 has a function of receiving a document DOC_O, metadata DOC_MD, and a summary Sum(1) (see FIG. 3A and FIG. 4). Note that the document DOC_O is a document before being translated. The metadata DOC_MD includes information related to the attribute of the document DOC_O.

For example, the category, writer's name and affiliation, and the like of the document DOC_O can be used as information related to the attribute. Moreover, the names of a publisher, a book, a magazine, a published material, and the like can be used as the information related to the attribute. In particular, in the category of documents related to a patent application, the names of an inventor, an applicant, and the like can be used as the information related to the attribute. File index (FI), F-term, IPC classification, and the like can also be used as the information related to the attribute.

The information processing device 10 has a function of cutting a character string with a predetermined length from the beginning of the document DOC_O and storing the character string in a block BLK(1) (see FIG. 3A). The information processing device 10 has a function of cutting a character string with a predetermined length following the block BLK(1) from the document DOC_O and storing the character string in a block BLK(2). For example, in the case where the document DOC_O is composed of a plurality of paragraphs, a character string in the first paragraph can be stored in the block BLK(1) and a character string in the next paragraph can be stored in the block BLK(2). In addition, a character string obtained by extracting a predetermined number of sentences from the beginning of the document DOC_O can be stored in the block BLK(1), and a character string obtained by extracting a predetermined number of sentences following the above sentences can be stored in the block BLK(2). In the case of an expression using a language and a character string, an array variable or the like can be used for the block BLK(1) and a translation Tr(1), for example.

### Structure Example 2 of Information Processing Device 10

The information processing device 10 has a function of generating and transmitting the prompt PT(11). For example, the information processing device 10 can transmit the prompt PT(11) to the information processing device 40 via the network 30 (see FIG. 1).

### Example 1 of Prompt PT(11)

The prompt PT(11) includes the block BLK(1), the metadata DOC_MD, and the summary Sum(1) (see FIG. 4). Note that the summary Sum(1) includes part of the block BLK(1). For example, a summarized text of the block BLK(1) which is made by a user of the information processing system of one embodiment of the present invention can be used as the summary Sum(1). A summarized text of the block BLK(1) which is made by using an information processing device capable of executing processing using a large language model can also be used as the summary Sum(1). Furthermore, a text that specifies an output format of a processing result can be included in the prompt. Specifically, it is possible to designate, as an output format, a format of a JavaScript Object Notation (abbreviation: JSON) and to supply a key as an item name.

The prompt PT(11) includes an instruction to translate the block BLK(1) to generate the translation Tr(1). In addition, the prompt PT(11) includes an instruction to translate the summary Sum(1) to generate a translation Tr(Sum(1)). Note that Tr( ) shown in FIG. 4 represents an instruction to translate a text.

For example, the character string stored in the block BLK(1) can be used as an “input sentence” shown in the next paragraph. In addition, a text that specifies a language used in the translated document can be included in the instruction. The metadata DOC_MD can be used as information specifying the range of a topic to which the block BLK(1) belongs.

Specifically, the following prompt can be used as the prompt PT(11). “Translate a patent specification. Process the “input sentence” and “summary of input sentence” by the following procedure and write processing results in the JSON format: 1. translate “input sentence” into English and set the key “Full Text”; 2. translate “summary of input sentence” into English and set the key “Summary”, Input sentence: block BLK(1), summary of input sentence: summary Sum(1)”.

### Structure Example 3 of Information Processing Device 10

The information processing device 10 has a function of generating and transmitting the prompt PT(21).

### Example 1 of Prompt PT(21)

The prompt PT(21) includes the translation Tr(Sum(1)), the block BLK(2), and the metadata DOC_MD (see FIG. 4).

The prompt PT(21) includes an instruction to translate the block BLK(2) by referring to the translation Tr(Sum(1)) to generate a translation RTr(2). In other words, the prompt PT(21) includes an instruction to generate a translation of the block BLK(2) by referring to the translation of the summary of the preceding block. The prompt PT(21) includes an instruction to extract part of the block BLK(2) and to translate the part by referring to the translation Tr(Sum(1)) to generate a translation RTr(Sum(2)). In other words, the prompt PT(21) includes an instruction to generate a translation of the summary of the block BLK(2) by referring to the translation of the summary of the preceding block. Note that RTr( ) shown in FIG. 4 represents an instruction to translate a text by referring to a specified document. In addition, RTr(Sum( )) shown in FIG. 4 represents an instruction to extract part of a predetermined document and to translate the extracted part of the document by referring to a specified document.

For example, the character string stored in the block BLK(2) can be used as an “input sentence” shown in the next paragraph. In addition, a text that specifies a language used in the translated document can be included in the instruction. The metadata DOC_MD can be used as information specifying the range of a topic to which the block BLK(2) belongs.

Specifically, the following prompt can be used as the prompt PT(21). “Translate a patent specification. Process the “input sentence”, “summary of input sentence”, and “translation of summary in the preceding block” by the following procedure and write processing results in the JSON format: 1. translate “input sentence” into English by referring to the “translation of summary in the preceding block” and set the key “Full Text”; 2. translate “summary of input sentence” into English by referring to the “translation of summary in the preceding block” and set the key “Summary”, input sentence: block BLK(2), summary of input sentence: summary Sum(2), translation of summary in the preceding block: translation Tr(Sum(1))”.

### Structure Example 4 of Information Processing Device 10

The information processing device 10 has a function of receiving the processing result RES(11) and the processing result RES(21).

The processing result RES(11) includes the translation Tr(1) and the translation Tr(Sum(1)) (see FIG. 4). Note that the translation Tr(1) includes a result of translating an expression in one language stored in the block BLK(1) into an expression in another language. For example, in the case of an expression using a language and a character string, an array variable or the like can be used for the block BLK(1) and the translation Tr(1). The translation Tr(Sum(1)) includes a result of translating the extracted part of the character string stored in the block BLK(1) into a predetermined language.

The processing result RES(21) includes the translation RTr(2) and the translation RTr(Sum(2)). The translation RTr(2) includes a result of translating the character string stored in the block BLK(2) into a predetermined language by referring to the translation Tr(Sum(1)). The translation RTr(Sum(2)) includes a result of translating the extracted part of the character string stored in the block BLK(2) into a predetermined language by referring to the translation Tr(Sum(1)).

The information processing device 10 has a function of extracting the translation Tr(1) and the translation Tr(Sum(1)) from the processing result RES(11) received via the network 30, for example. The information processing device 10 has a function of extracting the translation RTr(2) and the translation RTr(Sum(2)) from the processing result RES(21) received via the network 30, for example. The information processing device 10 has a function of generating a translated document DOC_TR using the translation Tr(1) and the translation RTr(2).

Thus, the document DOC_O can be divided into the block BLK(1) and the block BLK(2) to be translated. For example, the document DOC_O which is too long to be written into one prompt can be translated. The metadata DOC_MD can be used for the translation of the block BLK(1). The summary Sum(1) including part of the block BLK(1) can be prepared in advance and translated into the translation Tr(Sum(1)). In addition, the translation Tr(Sum(1)) and the metadata DOC_MD can be used for the translation of the block BLK(2). Moreover, it is possible to prevent occurrence of a contradiction between the translation Tr(1) as the translation result of the block BLK(1) and the translation RTr(2) as the translation result of the block BLK(2). In addition, the translated document DOC_TR with few inconsistencies in translation can be generated. Furthermore, the translated document DOC_TR with consistency can be generated. As a result, a novel information processing system that is highly convenient, useful, or reliable can be provided.

### Structure Example 2 of Information Processing System

An information processing system described in this embodiment is described with reference to FIG. 3B and FIG. 5. Note that the information processing system described in this embodiment with reference to FIG. 3B and FIG. 5 is different from the information processing system described with reference to FIG. 3A and FIG. 4 in that the information processing device 10 makes the information processing device 40 generate the summary Sum(1) with the use of the prompt PT(11). Different portions are described in detail here, and the above description is referred to for portions having the same structure as the above.

### Structure Example 5 of Information Processing Device 10

The information processing device 10 has a function of receiving the document DOC_O and the metadata DOC_MD. Note that the metadata DOC_MD includes information related to the attribute of the document DOC_O. The information processing device 10 has a function of receiving the processing result RES(11) and the processing result RES(21).

The information processing device 10 has a function of cutting a character string with a predetermined length from the beginning of the document DOC_O and storing the character string in the block BLK(1) (see FIG. 3B).

The information processing device 10 has a function of generating and transmitting the prompt PT(11).

### Example 2 of Prompt PT(11)

The prompt PT(11) includes the block BLK(1) and the metadata DOC_MD (see FIG. 5). Furthermore, the output format of the processing result can be specified in the prompt. Specifically, the JSON format can be specified as the output format, and a key can be given as an item name.

The prompt PT(11) includes an instruction to translate the block BLK(1) to generate the translation Tr(1). The prompt PT(11) also includes an instruction to extract part of the block BLK(1) and to translate the part to generate the translation Tr(Sum(1)). Note that Tr( ) shown in FIG. 5 represents an instruction to translate a text. Furthermore, Tr(Sum( )) represents an instruction to extract part of a predetermined document and to translate the extracted part of the document. Furthermore, RTr( ) represents an instruction to translate a text by referring to a specified document. Furthermore, RTr(Sum ( )) represents an instruction to extract part of a predetermined document and to translate the extracted part of the document by referring to a specified document.

For example, the character string stored in the block BLK(1) can be used as an “input sentence” shown in the next paragraph. Furthermore, the language used in the translated document can be included in the instruction. The metadata DOC_MD can be used as information specifying the range of a topic to which the block BLK(1) belongs.

Specifically, the following prompt can be used as the prompt PT(11). “Translate a patent specification. Process the “input sentence” by the following procedure and write a processing result in the JSON format: 1. translate “input sentence” into English and set the key “Full Text”; 2. summarize “Full Text” and set the key “Summary”, input sentence: block BLK(1).

Thus, the document DOC_O can be divided into the block BLK(1) and the block BLK(2) to be translated. For example, the document DOC_O which is too long to be written into one prompt can be translated. The metadata DOC_MD can be used for the translation of the block BLK(1). Furthermore, part of the block BLK(1) can be extracted and then translated into the translation Tr(Sum(1)). In addition, the translation Tr(Sum(1)) and the metadata DOC_MD can be used for the translation of the block BLK(2). Moreover, it is possible to prevent occurrence of a contradiction between the translation Tr(1) as the translation result of the block BLK(1) and the translation RTr(2) as the translation result of the block BLK(2). In addition, the translated document DOC_TR with few inconsistencies in translation can be generated. Furthermore, the translated document DOC_TR with consistency can be generated. As a result, a novel information processing system that is highly convenient, useful, or reliable can be provided.

### Structure Example 3 of Information Processing System

The information processing system described in this embodiment includes the information processing device 40 and the information processing device 10 (see FIG. 1). The information processing system includes the information terminal 20.

### Structure Example 2 of Information Processing Device 40

The information processing device 40 has a function of receiving a group of prompts PT(1) in sequence. The information processing device 40 has a function of generating a group of processing results RES(1) in sequence in accordance with the group of prompts PT(1) and transmitting the group of processing results RES(1).

The information processing device 40 has a function of receiving a group of prompts PT(2) in sequence. The information processing device 40 has a function of generating a group of processing results RES(2) in sequence in accordance with the group of prompts PT(2) and transmitting the group of processing results RES(2).

### Structure Example 6 of Information Processing Device 10

The information processing device 10 has a function of receiving the document DOC_O and the metadata DOC_MD (see FIG. 3C and FIG. 6). Note that the metadata DOC_MD includes information related to the attribute of the document DOC_O.

The information processing device 10 has a function of cutting a character string with a predetermined length from the beginning of the document DOC_O and storing the character string in the block BLK(1) (see FIG. 3C). The information processing device 10 has a function of cutting a character string with a predetermined length following the block BLK(1) from the document DOC_O and storing the character string in the block BLK(2) (see FIG. 3C).

### Structure Example 7 of Information Processing Device 10

The information processing device 10 has a function of generating and transmitting the group of prompts PT(1) in sequence.

### Example 1 of Group of Prompts PT(1)

The prompts PT(1) in the group each include the block BLK(1) and the metadata DOC_MD (see FIG. 6).

The prompts PT(1) in the group each include an instruction to translate the block BLK(1) to generate the translation Tr(1). The prompts PT(1) in the group each include an instruction to extract part of the block BLK(1) and to translate the part to generate the translation Tr(Sum(1)).

The prompts PT(1) in the group each include an instruction to compare the block BLK(1) and the translation Tr(1) to generate correction information CI(1). Note that the correction information CI(1) includes a mistranslated expression included in the translation Tr(1), the original expression included in the block BLK(1) of the mistranslated expression, and a proofread expression by correction. In addition, CI( ) shown in FIG. 6 represents an instruction to compare a text before being translated and a translated text to collect the correction information. The prompts PT(1) in the group each include an instruction to compare the block BLK(1) and the translation Tr(1) to generate a proofread translation TrPF(1). The prompts PT(1) in the group each include an instruction to compare the block BLK(1) and the translation Tr(Sum(1)) to generate a proofread translation TrPF(Sum(1)). Note that TrPF( ) shown in FIG. 6 represents an instruction to compare a text before being translated and a translated text to proofread the text.

For example, the prompt PT(11) and the prompt PT(12) can be used in the group of prompts PT(1).

For example, the character string stored in the block BLK(1) can be used as an “input sentence” shown in the next paragraph. Furthermore, the language used in the translated document can be included in the instruction. The metadata DOC_MD can be used as information specifying the range of a topic to which the block BLK(1) belongs.

Specifically, the following prompt can be used as the prompt PT(11). “Translate a patent specification. Process the next “input sentence” by the following procedure and write a processing result in the JSON format: 1. translate “input sentence” into English and set the key “Full Text”; 2. summarize “Full Text” and set the key “Summary”, Input sentence: block BLK(1).

Specifically, the following prompt can be used as the prompt PT(12). “Translate a patent specification. Process the “Japanese sentence” and “English-translated sentence” by the following procedure and write processing results in the JSON format: 1. compare “Japanese sentence” and “English-translated sentence” to check whether a mistranslation is included, and set the key “Check Result”; 2. correct the mistranslation in “English-translated sentence” and set the key “Corrected English-translated Sentence”, 3. correct the mistranslation in “English-translated Summary” and set the key “Corrected English-translated Summary”, Japanese sentence: block BLK(1), English-translated sentence: translation TR(1), English-translated summary: translation Tr(Sum(1))”.

### Structure Example 8 of Information Processing Device 10

The information processing device 10 has a function of generating and transmitting the group of prompts PT(2) in sequence.

### Example 2 of Group of Prompts PT(2)

The prompts PT(2) in the group each include the block BLK(2), the metadata DOC_MD, the proofread translation TrPF(Sum(1)), and the correction information CI(1) (see FIG. 6).

The prompts PT(2) in the group each include an instruction to translate the block BLK(2) by referring to the proofread translation TrPF(Sum(1)) and the correction information CI(1) to generate the translation RTr(2). The prompts PT(2) in the group each include an instruction to extract part of the block BLK(2) and to generate the translation RTr(Sum(2)) by referring to the proofread translation TrPF(Sum(1)) and the correction information CI(1).

The prompts PT(2) in the group each include an instruction to compare the block BLK(2) and the translation RTr(2) to generate correction information CI(2). Note that the correction information CI(2) includes a mistranslated expression included in the translation RTr(2), the original expression included in the block BLK(2) of the mistranslated expression, and a proofread expression by correction. The prompts PT(2) in the group each include an instruction to compare the block BLK(2) and the translation RTr(2) to generate a proofread translation TrPF(2). The prompts PT(2) in the group each include an instruction to compare the block BLK(2) and the translation RTr(Sum(2)) to generate a proofread translation TrPF(Sum(2)).

For example, the prompt PT(21) and the prompt PT(22) can be used in the group of prompts PT(2).

For example, the character string stored in the block BLK(2) can be used as an “input sentence” shown in the next paragraph. Furthermore, the language used in the translated document can be included in the instruction. The metadata DOC_MD can be used as information specifying the range of a topic to which the block BLK(2) belongs.

Specifically, the following prompt can be used as the prompt PT(21). “Translate a patent specification. Process the “input sentence” by the following procedure and write a processing result in the JSON format: 1. translate “input sentence” into English by referring to “translation of the summary of the preceding block” and “mistranslation information in the preceding block” and set the key “Full Text”; 2. summarize “Full Text” and set the key “Summary”, input sentence: block BLK(1), translation of the summary of the preceding block: TrPF(Sum(1)), mistranslation information in the preceding block: CI(1)”.

Specifically, the following prompt can be used as the prompt PT(22). “Translate a patent specification. Process the “Japanese sentence” and “English-translated sentence” by the following procedure and write processing results in the JSON format: 1. compare “Japanese sentence” and “English-translated sentence” to check whether a mistranslation is included and set the key “Check Result”; 2. correct the mistranslation in “English-translated sentence” and set the key “corrected English-translated sentence”; 3. correct the mistranslation in “English-translated summary” and set the key “Corrected English-translated Summary”, Japanese sentence: block BLK(2), English-translated sentence: translation TR(2), English-translated sentence: translation Tr(Sum(2))”.

### Structure Example 9 of Information Processing Device 10

The information processing device 10 has a function of receiving the group of processing results RES(1) and the group of processing results RES(2).

The processing results RES(1) in the group each include the translation Tr(1), the translation Tr(Sum(1)), the proofread translation TrPF(1), the proofread translation TrPF(Sum(1)), and the correction information CI(1) (see FIG. 6). Note that the translation Tr(1) includes a result of translating the character string stored in the block BLK(1) into a predetermined language. The translation Tr(Sum(1)) includes a result of translating extracted part of the character string stored in the block BLK(1) into a predetermined language. The proofread translation TrPF(1) includes a result of proofreading the character string stored in the translation Tr(1) by comparing the block BLK(1) and the translation Tr(1). The proofread translation TrPF(Sum(1)) includes a result of proofreading the character string stored in the translation Tr(Sum(1)) by comparing the block BLK(1) and the translation Tr(Sum(1)). In addition, the correction information CI(1) includes a mistranslated expression included in the translation Tr(1), the original expression included in the block BLK(1) of the mistranslated expression, and a proofread expression by correction.

The processing results RES(2) in the group each include the translation RTr(2), the translation RTr(Sum(2)), the proofread translation TrPF(2), the proofread translation TrPF(Sum(2)), and the correction information CI(2). The translation RTr(2) includes a result of translating the character string stored in the block BLK(2) into a predetermined language by referring to the translation Tr(Sum(1)). The translation RTr (Sum(2)) includes a result of translating extracted part of the character string stored in the block BLK(2) into a predetermined language by referring to the translation Tr (Sum(1)). The proofread translation TrPF (Sum(2)) includes a result of proofreading the character string stored in the translation Tr(Sum(2)) by comparing the block BLK(2) and the translation Tr(Sum(2)). The correction information CI(2) includes a mistranslated expression included in the translation RTr(2), the original expression in the block BLK(2) of the mistranslated expression included, and a proofread expression by correction.

The information processing device 10 has a function of extracting the proofread translation TrPF(1) from the group of processing results RES(1), and has a function of extracting the proofread translation TrPF(2) from the group of processing results RES(2). Furthermore, the information processing device 10 has a function of generating the translated document DOC_TR using the proofread translation TrPF(1) and the proofread translation TrPF(2).

Thus, the document DOC_O can be divided into a block BLK(1) and a block BLK(2) to be translated. For example, the document DOC_O which is too long to be written into one prompt can be translated. The metadata DOC_MD can be used for the translation of the block BLK(1). Furthermore, part of the block BLK(1) can be extracted and then translated into the translation Tr(Sum(1)). In addition, the proofread translation TrPF(1) can be generated by comparing the block BLK(1) and the translation Tr(1). The proofread translation TrPF(Sum(1)) can be generated by comparing the block BLK(1) and the translation Tr(Sum(1)). For the translation of the block BLK(2), the proofread translation TrPF(Sum(1)), the correction information CI(1), and the metadata DOC_MD can be used. Moreover, it is possible to prevent occurrence of a contradiction between the proofread translation TrPF(Sum(1)) obtained by proofreading the translation result of the summary of the block BLK(1) and the proofread translation TrPF(2) obtained by proofreading the translation result of the block BLK(2). In addition, the translated document DOC_TR with few inconsistencies in translation can be generated. Furthermore, the translated document DOC_TR with consistency can be generated. As a result, a novel information processing system that is highly convenient, useful, or reliable can be provided.

### Structure Example 4 of Information Processing System

The information processing system of one embodiment of the present invention includes the information processing device 10 and the information processing device 40 (see FIG. 1). The information processing system of one embodiment of the present invention includes the information terminal 20. Note that there is no particular limitation on the number of information terminals 20. For example, four information terminals 20 are illustrated in FIG. 1; however, the number of the information terminals may be one, two, three, or five or more.

### Structure Example 10 of Information Processing Device 10

The information processing device 10 can transmit data received from the information terminal 20 to the information processing device 40. The information processing device 10 can transmit data received from the information processing device 40 to the information terminal 20.

The information processing device 10 can process the received data and transmit the processing result. For example, the information processing device 10 can execute processing using the information processing method of one embodiment of the present invention.

The information processing device 10 can transmit data generated on the basis of data received from the information terminal 20 to the information processing device 40. The information processing device 10 can transmit data generated on the basis of data received from the information processing device 40 to the information terminal 20.

Note that an organization such as a company that provides a service (hereinafter also referred to as a service provider) using the information processing method of one embodiment of the present invention can provide a service to users with the use of the information processing device 10.

For example, a large computer such as a server computer or a supercomputer can be used as the information processing device 10.

A computer having a function of a parallel computer can be used as the information processing device 10. Thus, large-scale computation necessary for learning and inference of artificial intelligence (AI) can be performed, for example. In addition, processing using a natural language processing model using AI can be performed.

### Structure Example 3 of Information Processing Device 40

The information processing device 40 can process the received data and transmit the processing result. For example, the information processing device 40 can perform arithmetic processing or the like using data received from the information processing device 10. The information processing device 40 can transmit the processing result to the information processing device 10. Accordingly, the load of arithmetic processing on the information processing device 10 can be reduced.

The information processing device 40 can perform processing using a natural language processing model using AI. For example, processing using a natural language processing model using AI such as Bidirectional Encoder Representations from Transformers (BERT) or Text-to-Text Transfer Transformer (T5) can be executed.

Furthermore, the information processing device 40 can perform processing using a model (a text generation model, a conversation model, or the like) utilizing a large language model. For example, processing using a large language model such as GPT-3, GPT-3.5, GPT-4, Language Model for Dialogue Applications (LaMDA), Pathways Language Model (PaLM), or Llama2 can be executed. In particular, GPT-4 is preferably used.

For example, the information processing device 40 can translate a document written in a language A into a document written in a language B. Furthermore, the information processing device 40 can translate a document written in the language A into a document written in the language B in accordance with a given prompt. Furthermore, a restriction condition can be included in the prompt. In that case, the degree of freedom of translation can be controlled by giving the restriction condition.

Furthermore, the information processing device 40 can execute processing using a general-purpose language processing model capable of performing a variety of natural language processing tasks.

The information processing device 40 is a large computer such as a server computer or a supercomputer. The information processing device 40 preferably has a function of a parallel computer. When the information processing device 40 is used as a parallel computer, large-scale computation necessary for AI learning and inference can be performed, for example.

Note that the information processing device 40 is a computer having higher processing capacity than the information processing device 10. For example, in the case where both the information processing device 10 and the information processing device 40 have a function of a parallel computer, the information processing device 40 has high processing capacity and can perform large-scale computation as compared with the information processing device 10. For example, in the case where both the information processing device 10 and the information processing device 40 can perform processing using a model utilizing a large language model, the information processing device 40 can execute processing using a large-scale AI model as compared with the information processing device 10.

Note that a service provider does not necessarily have its own information processing device 40. For example, a service provider can utilize part of the service that another company or the like provides using the information processing device 40.

### Structure Example of Information Terminal 20

The information terminal 20 can receive data input by the user of the information processing system of one embodiment of the present invention. The information terminal 20 can provide data output from the information processing system of one embodiment of the present invention to the user.

The information terminal 20 can transmit data received from the user to the information processing device 10. The information terminal 20 can provide data received from the information processing device 10 to the user.

The information terminal 20 can transmit data generated on the basis of data received from the user to the information processing device 10. The information terminal 20 can provide data generated on the basis of data received from the information processing device 10 to the user.

Dedicated application software, a web browser, or the like are installed on the information terminal 20, for example. The user can access the information processing device 10 through the dedicated application software, the web browser, or the like. Thus, the user can enjoy a service using the information processing system of one embodiment of the present invention with the use of a computer with lower processing capacity than the information processing device 10, for example.

The information terminals 20 can also be referred to as client computers or the like. The information terminals 20 are each an information terminal device used by the user of the information processing system of one embodiment of the present invention.

For example, a desktop computer 20a, a notebook computer 20b, a smartphone 20c, and a tablet computer 20d can be used as the information terminals 20. Note that the tablet computer 20d can also be used as a laptop computer when connected to a housing 21 including a keyboard.

### <<Network 30>>

The network 30 connects the information processing device 10 and the information processing device 40. Thus, input data and processed data can be transmitted and received between the information processing device 10 and the information processing device 40. Furthermore, loads relating to information processing can be dispersed.

Note that in this embodiment, the case where the network 30 is a larger computer network than the network 31 will be mainly described. For example, a global network can be used as the network 30. Specifically, the Internet, which is an infrastructure of the World Wide Web (WWW), can be used.

### <<Network 31>>

The network 31 connects the plurality of information terminals 20 and the information processing device 10. Thus, data can be transmitted and received between the plurality of information terminals 20 and the information processing device 10. Furthermore, loads relating to information processing can be dispersed. Furthermore, the service provider can provide a service using the information processing method of one embodiment of the present invention to the user through the network 31, for example.

For example, a local network can be used as the network 31. An intranet or an extranet can be used as the network 31. In addition, a network such as a personal area network (PAN), a local area network (LAN), a campus area network (CAN), a metropolitan area network (MAN), a wide area network (WAN), or a global area network (GAN) can be used the network 31.

In the case where a service provider using the information processing method of one embodiment of the present invention and the user who enjoys the service belong to the same organization such as a company, data transmission and reception between the information terminal 20 and the information processing device 10 is preferably performed using the network 31 constructed in the organization, for example. Thus, data can be transmitted and received between the information terminal 20 and the information processing device 40 more safely than in the case where data is transmitted via the Internet. Furthermore, leakage of confidential information in the organization to the outside can be prevented.

For wireless communication, it is possible to use, as a communication protocol or a communication technology, the fourth-generation (4G) mobile communication system, the fifth-generation (5G) mobile communication system, the sixth-generation (6G) mobile communication system, or a communication standard developed by IEEE such as Wi-Fi (registered trademark) or Bluetooth (registered trademark).

### Structure Example 11 of Information Processing Device 10

The information processing device 10 includes an input unit 110, a memory unit 120, a processing unit 130, an output unit 140, and a transmission path 150 (see FIG. 2).

Although the block diagram in drawings attached to this specification illustrates components classified by their functions as independent blocks, it is difficult to classify actual components by their functions completely, and one component can have a plurality of functions. For example, part of the processing unit 130 may function as the input unit 110. In addition, one function can be involved in a plurality of components. For example, processing executed by the processing unit 130 may be executed in different servers depending on processing content.

### [Input Unit 110]

The input unit 110 can receive data from the outside of the information processing device 10. For example, the input unit 110 receives data from the information terminal 20.

The input unit 110 supplies received data to one or both of the memory unit 120 and the processing unit 130 through the transmission path 150.

### [Memory Unit 120]

The memory unit 120 has a function of storing a program to be executed by the processing unit 130. The memory unit 120 may have a function of storing data (e.g., an arithmetic result, an analysis result, and an inference result) generated by the processing unit 130, data received by the input unit 110, and the like.

The memory unit 120 may include a database. The information processing device 10 may include another database in addition to the memory unit 120. The information processing device 10 may have a function of extracting data from a database in the outside of the memory unit 120, in the outside of the information processing device 10, or in the outside of the information processing system. Alternatively, the information processing device 10 may have a function of extracting data from both of its own database and an external database.

One or both of a storage and a file server can be used in the memory unit 120. In addition, a database in which a path of a file stored in the file server is recorded can be used for the memory unit 120.

The memory unit 120 includes at least one of a volatile memory and a nonvolatile memory. Examples of the volatile memory include a dynamic random-access memory (DRAM) and a static random-access memory (SRAM). Examples of the nonvolatile memory include a resistive random-access memory (ReRAM, also referred to as a resistance-change memory), a phase-change random-access memory (PRAM), a ferroelectric random-access memory (FeRAM), a magnetoresistive random-access memory (MRAM, also referred to as a magnetoresistive memory), and a flash memory. The memory unit 120 may include at least one of a nonvolatile oxide semiconductor random-access memory (NOSRAM, registered trademark) and a dynamic oxide semiconductor random-access memory (DOSRAM, registered trademark). The memory unit 120 may include a recording media drive. Examples of the recording media drive include a hard disk drive (HDD) and a solid-state drive (SSD).

Note that “NOSRAM” is an abbreviation for a nonvolatile oxide semiconductor random-access memory (RAM). A NOSRAM is a memory in which a memory cell is a 2-transistor (2T) or 3-transistor (3T) gain cell and a transistor using a metal oxide in a channel formation region (also referred to as an OS transistor) is used. An OS transistor has an extremely low current that flows between a source and a drain in an off state, that is, an extremely low leakage current. The NOSRAM can be used as a nonvolatile memory by retaining electric charge corresponding to data in a memory cell, using characteristics of extremely low leakage current. In particular, the NOSRAM is capable of reading retained data without destruction (non-destructive reading), and thus is suitable for arithmetic processing in which only a data reading operation is repeated many times. Since the NOSRAM stacked over another component can have large data capacity, the performance of a semiconductor device can be increased by using the NOSRAM as a large cache memory, a main memory, or a storage memory.

The DOSRAM is an abbreviation for dynamic oxide semiconductor RAM, which indicates a RAM including one transistor (1T) and one capacitor (1C). The DOSRAM is a DRAM formed using an OS transistor, and a memory that temporarily stores data sent from the outside. The DOSRAM is a memory utilizing a low off-state current of the OS transistor.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium and contains any of zinc, gallium, and tin, e.g., zinc tin oxide and gallium tin oxide.

### [Processing Unit 130]

The processing unit 130 has a function of performing processing such as arithmetic processing, analysis, and inference with the use of data supplied from one or both of the input unit 110 and the memory unit 120. The processing unit 130 can supply processed data (e.g., an arithmetic result, an analysis result, or an inference result) to one or both of the memory unit 120 and the output unit 140.

The processing unit 130 has a function of obtaining data from the memory unit 120. The processing unit 130 may have a function of storing or registering data in the memory unit 120.

The processing unit 130 can include an arithmetic circuit, for example. The processing unit 130 can include, for example, a central processing unit (CPU). The processing unit 130 can include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. The processing unit 130 can interpret and execute instructions from programs to process various kinds of data and control programs. The programs to be executed by the processor are stored in at least one of the memory unit 120 and a memory region of the processor.

The processing unit 130 may include a main memory. The main memory includes at least one of a volatile memory such as a random-access memory (RAM) and a nonvolatile memory such as a read only memory (ROM). The main memory may include at least one of the above-described NOSRAM and DOSRAM.

For example, a DRAM, an SRAM, or the like is used as the RAM, a virtual memory space is assigned and utilized as a working space of the processing unit 130. An operating system, an application program, a program module, program data, a look-up table, and the like which are stored in the memory unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (Si transistor).

The processing unit 130 preferably includes an OS transistor. The OS transistor has an extremely low off-state current; therefore, with the use of the OS transistor as a switch for retaining electric charge (data) that has flowed into a capacitor functioning as a memory element, a long data retention period can be obtained. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information processing system can be reduced.

For at least part of the processing of the information processing device 10, AI is preferably used.

In particular, the information processing device 10 preferably uses an artificial neural network (ANN; hereinafter just referred to as neural network in some cases). The neural network can be constructed with circuits (hardware) or programs (software).

In this specification and the like, the neural network indicates a general model having the capability of solving problems, which is modeled on a biological neural network and determines the connection strength of neurons by the learning. The neural network includes an input layer, a middle layer (hidden layer), and an output layer.

In the description of the neural network in this specification and the like, to determine a connection strength of neurons (also referred to as weight coefficient) from the existing information is referred to as “leaning” in some cases.

In this specification and the like, to draw a new conclusion from a neural network formed with the connection strength obtained by learning is referred to as “inference” in some cases.

### [Output Unit 140]

The output unit 140 can output at least one of an arithmetic result, an analysis result, and an inference result in the processing unit 130 to the outside of the information processing device 10.

For example, the output unit 140 can transmit data to the information processing device 40. The output unit 140 can transmit data to the information terminal 20.

### [Transmission Path 150]

The transmission path 150 has a function of transmitting data. Data transmission and reception among the input unit 110, the memory unit 120, the processing unit 130, and the output unit 140 can be performed through the transmission path 150.

Note that this embodiment can be combined with any of the other embodiments in this specification as appropriate.

### Embodiment 2

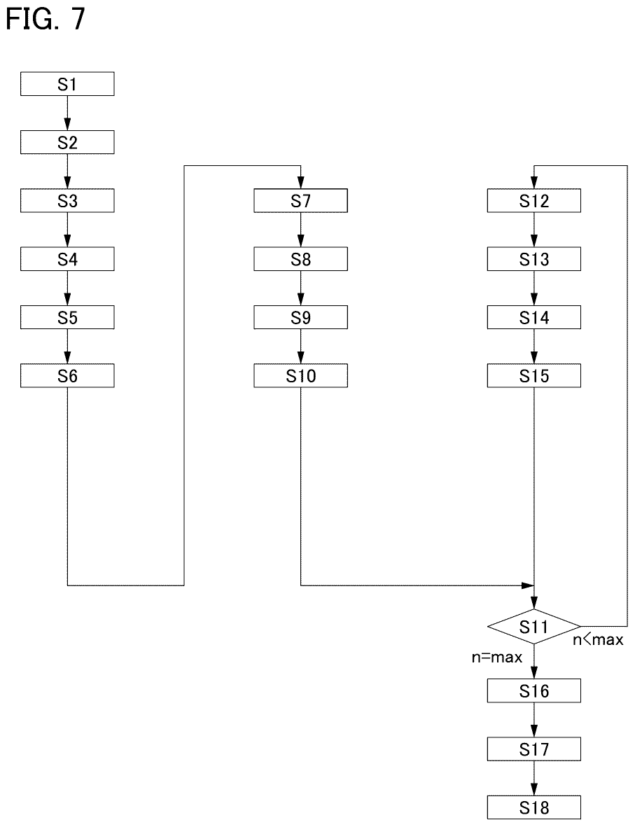

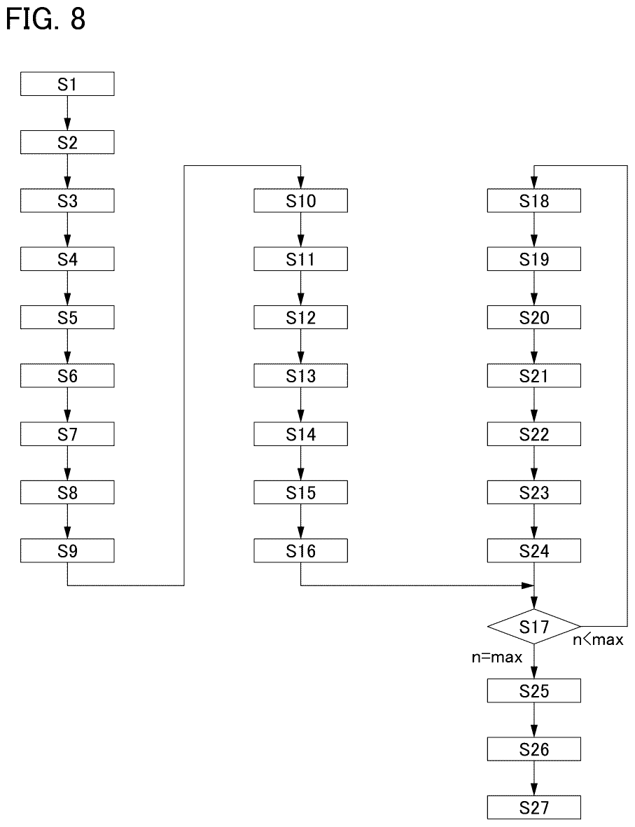

In this embodiment, an information processing method of one embodiment of the present invention will be described with reference to FIG. 7 and FIG. 8.

FIG. 7 illustrates an example of an information processing method of one embodiment of the present invention.

FIG. 8 illustrates another example of an information processing method of one embodiment of the present invention.

### Example 1 of Information Processing Method

The information processing method described in this embodiment includes Step S1 to Step S18 (see FIG. 7).

In Step S1 and Step S2, the information processing device 10 store the document DOC_O, the metadata DOC_MD, and the summary Sum(1) that the information terminal 20 has received.

Step S3 to Step S6 are processing for the first portion of the document DOC_O.

Step S7 to Step S10 are processing for a portion following the first portion of the document DOC_O.

Step S11 is processing for determining a branch.

Step S12 to Step S15 are processing for an n-th portion following an n−1-th portion of the document DOC_O.

Step S16 is processing for generating the translated document DOC_TR from the processing result RES(11) to a processing result RES(max1). Note that the last of the document DOC_O is stored in a block BLK(max). Note that n and max are each an integer greater than or equal to 2, and n is an integer less than or equal to max.

In Step S17 and Step S18, the translated document DOC_TR is stored in the information terminal 20.

### [Step S1]

In Step S1, the information terminal 20 receives and transmits the document DOC_O, the metadata DOC_MD, and the summary Sum(1) (see FIG. 7). For example, the user of the information processing system of one embodiment of the present invention inputs the document DOC_O and the metadata DOC_MD to the information terminal 20. For example, information specifying a language used in the translated document can be input.

### [Step S2]

In Step S2, the information processing device 10 receives and stores the document DOC_O, the metadata DOC_MD, and the summary Sum(1).

### [Step S3]

In Step S3, the information processing device 10 cuts a character string with a predetermined length from the beginning of the document DOC_O and stores the character string in the block BLK(1).

### [Step S4]

In Step S4, the information processing device 10 generates and transmits the prompt PT(11).

Note that the prompt PT(11) includes the block BLK(1), the metadata DOC_MD, and the summary Sum(1), and the summary Sum(1) includes part of the first block BLK(1). The prompt PT(11) includes an instruction to translate the block BLK(1) to generate the translation Tr(1). In addition, the prompt PT(11) includes an instruction to translate the summary Sum(1) to generate the translation Tr(Sum(1)).

### [Step S5]

In Step S5, the information processing device 40 receives the prompt PT(11), generates the processing result RES(11) in accordance with the prompt PT(11), and transmits the processing result RES(11).

Note that the processing result RES(11) includes the translation Tr(1) and the translation Tr(Sum(1)).

### [Step S6]

In Step S6, the information processing device 10 receives and stores the processing result RES(11).

### [Step S7]

In Step S7, the information processing device 10 cuts a character string with a predetermined length following the block BLK(1) from the document DOC_O and stores the character string in the block BLK(2).

### [Step S8]

In Step S8, the information processing device 10 generates and transmits the prompt PT(21).

Note that the prompt PT(21) includes the translation Tr(Sum(1)), the block BLK(2), and the metadata DOC_MD. The prompt PT(21) includes an instruction to translate the block BLK(2) by referring to the translation Tr(Sum(1)) to generate the translation RTr(2). In this manner, it is possible to prevent occurrence of a contradiction between the translation Tr(Sum(1)) as the translation result of the summary Sum(1) and the translation RTr(2) as the translation result of the block BLK(2). The prompt PT(21) includes an instruction to extract part of the block BLK(2) and to translate the part by referring to the translation Tr(Sum(1)) to generate the translation RTr(Sum(2)). In this manner, it is possible to prevent occurrence of a contradiction between the translation Tr(Sum(1)) as the translation result of the summary Sum(1) and the translation RTr(Sum(2)) as the translation result of the summary of the block BLK(2).

### [Step S9]

In Step S9, the information processing device 40 receives the prompt PT(21), generates the processing result RES(21) in accordance with the prompt PT(21), and transmits the processing result RES(21). Note that the processing result RES(21) includes the translation RTr(2) and the translation RTr(Sum(2)).

### [Step S10]

In Step S10, the information processing device 10 receives the processing result RES(21) and stores the processing result RES(21) following the preceding processing result in sequence.

### [Step S11]

In the case where the last of the document DOC_O is included in the character string cut by the information processing device 10 in Step S11, the last processing result is set as the processing result RES(max1) and the process proceeds to Step S16. For example, in the case where the last of the document DOC_O is included in the block BLK(2), the preceding processing result RES(21) is the processing result RES(max1). Similarly, in the case where the last of the document DOC_O is included in a block BLK(n), the preceding processing result RES(n1) is set as the processing result RES(max1). Alternatively, in the case where the last of the document DOC_O is not included in the character string cut by the information processing device 10, the process proceeds to Step S12 until the last of the document DOC_O is included. For example, in the case where the last of the document DOC_O is not included in the block BLK(2), adding 1 to 2, which is the value of an identifier, makes 3 and 3 is used as an identifier of blocks used in Step S12 to Step S15. Similarly, in the case where the last of the document DOC_O is not included in a block BLK(n−1), adding 1 to n−1, which is the value of an identifier, makes n, and n is used as an identifier of blocks used in Step S12 to Step S15. Note that the processing result RES(max1) includes a translation RTr(max), and the translation RTr(max) includes the translation of the character string that is cut last.

### [Step S12]

In Step S12, the information processing device 10 cuts a character string with a predetermined length following the preceding block BLK(n−1) from the document DOC_O and stores the character string in the block BLK(n).

### [Step S13]

In Step S13, the information processing device 10 generates and transmits a prompt PT(n1).

Note that a prompt PT(n1) includes a translation RTr(Sum(n−1)), the block BLK(n), and the metadata DOC_MD, and the translation RTr(Sum(n−1)) includes a translation of part of the preceding block BLK(n−1). The prompt PT(n1) includes an instruction to translate the block BLK(n) by referring to the translation Tr(Sum(n−1)) to generate a translation RTr(n). In this manner, it is possible to prevent occurrence of a contradiction between the translation RTr (Sum(n−1)) as the translation result of the summary of the block BLK(n−1) and the translation RTr(n) as the translation result of the block BLK(n). In addition, the prompt PT(n1) includes an instruction to extract part of the block BLK(n) and to translate the part by referring to the translation Tr(Sum(n−1)) to generate a translation RTr(Sum(n)). In this manner, it is possible to prevent occurrence of a contradiction between the translation RTr(Sum(n−1)) as the translation result of the summary of the block BLK(n−1) and the translation RTr(Sum(n)) as the translation result of the summary of the block BLK(n).

### [Step S14]

In Step S14, the information processing device 40 receives the prompt PT(n1), generates the processing result RES(n1) in accordance with the prompt PT(n1) and transmits the processing result RES(n1). Note that the processing result RES(n1) includes the translation Tr(n) and the translation Tr(Sum(n)).

### [Step S15]

In Step S15, the information processing device 10 receives the processing result RES(n1) and stores the processing result RES(n1) following the preceding processing result in sequence, and the process proceeds to Step S11.

### [Step S16]

In Step S16, the information processing device 10 extracts the translations in sequence from the processing results stored in sequence, and generates the translated document DOC_TR. Note that the translated document DOC_TR includes the translation Tr(1) and the translation RTr(max). For example, in the case where the last of the document DOC_O is included in the block BLK(2), the information processing device 10 stores the processing result RES(11) and the processing result RES(21), extracts the translation Tr(1) from the processing result RES(11), extracts the translation Tr(2) from the processing result RES(21), and generates the translated document DOC_TR. In the case where the last of the document DOC_O is included in a block BLK(3), the information processing device 10 stores the processing result RES(11), the processing result RES(21), and a processing result RES(31), extracts the translation Tr(1) from the processing result RES(11), extracts the translation Tr(2) from the processing result RES(21), extracts a translation Tr(3) from the processing result RES(31), and generates the translated document DOC_TR. In the case where the last of the document DOC_O is included in the block BLK(n), the information processing device 10 stores the processing result RES(11), the processing result RES(21), and the processing result RES(31) to the processing result RES(n1), extracts the translation Tr(1) from the processing result RES(11), extracts the translation Tr(2) from the processing result RES(21), extracts the translation Tr(3) to the translation Tr(n) from the processing result RES(31) to the processing result RES(n1), respectively, and generates the translated document DOC_TR. For example, all the extracted translations are combined in sequence to generate the translated document DOC_TR.

### [Step S17]

In Step S17, the information processing device 10 transmits the translated document DOC_TR to the information terminal 20.

### [Step S18]

In Step S18, the information terminal 20 receives and stores the translated document DOC_TR.

Thus, the document DOC_O can be divided into the block BLK(1) and the block BLK(2) to be translated. For example, the document DOC_O which is too long to be written into one prompt can be translated. The metadata DOC_MD can be used for the translation of the block BLK(1). In addition, the summary Sum(1) including part of the block BLK(1) can be prepared in advance and translated into the translation Tr(Sum(1)). The translation Tr(Sum(1)) and the metadata DOC_MD can be used for the translation of the block BLK(2). Moreover, it is possible to prevent occurrence of a contradiction between the translation Tr(1) as the translation result of the block BLK(1) and the translation RTr(2) as the translation result of the block BLK(2). Furthermore, the translated document DOC_TR with few inconsistencies in translation can be generated. The translated document DOC_TR with consistency can be generated. As a result, a novel information processing method that is highly convenient, useful, or reliable can be provided.

### Example 2 of Information Processing Method

An example 2 of the information processing method described in this embodiment includes Step S1 to Step S18 (see FIG. 7). Note that the example 2 is different from the above-described example 1 of information processing method in the following points: in Step S1 and Step S2, the summary Sum(1) is not used; and in Step 4, the prompt PT(11) includes an instruction to extract part of the block BLK(1) and to translate the part to generate the translation Tr(Sum(1)). Different portions are described in detail here, and the above description is referred to for portions having the same structure as the above.

### [Step S1]

In Step S1, the information terminal 20 receives and transmits the document DOC_O and the metadata DOC_MD.

### [Step S2]

In Step S2, the information processing device 10 receives and stores the document DOC_O and the metadata DOC_MD.

### [Step S3]

In Step S3, the information processing device 10 cuts a character string with a predetermined length from the beginning of the document DOC_O and stores the character string in the block BLK(1).

### [Step S4]

In Step S4, the information processing device 10 generates and transmits the prompt PT(11).

Note that the prompt PT(11) includes the block BLK(1) and the metadata DOC_MD. The prompt PT(11) includes an instruction to translate the block BLK(1) to generate the translation Tr(1). The prompt PT(11) includes an instruction to extract part of the block BLK(1) and to translate the part to generate the translation Tr(Sum(1)).

Thus, the document DOC_O can be divided into the block BLK(1) and the block BLK(2) to be translated. For example, the document DOC_O which is too long to be written into one prompt can be translated. The metadata DOC_MD can be used for the translation of the block BLK(1). Furthermore, part of the block BLK(1) can be extracted and translated into the translation Tr(Sum(1)). The translation Tr(Sum(1)) and the metadata DOC_MD can be used for the translation of the block BLK(2). Moreover, it is possible to prevent occurrence of a contradiction between the translation Tr(1) as the translation result of the block BLK(1) and the translation RTr(2) as the translation result of the block BLK(2). Furthermore, the translated document DOC_TR with few inconsistencies in translation can be generated. The translated document DOC_TR with consistency can be generated. As a result, a novel information processing method that is highly convenient, useful, or reliable can be provided.

### Example 3 of Information Processing Method

An information processing method described in this embodiment includes Step S1 to Step S27 (see FIG. 8).

In Step S1 and Step S2, the information processing device 10 stores the document DOC_O, the metadata DOC_MD, and the summary Sum(1) that the information terminal 20 has received.

Step S3 to Step S9 are processing for the first portion of the document DOC_O.

Step S10 to Step S16 are processing for a portion following the first portion of the document DOC_O.

Step S17 is processing for determining a branch.

Step S18 to Step S24 are processing for the n-th portion following the n−1-th portion of the document DOC_O.

Step S25 is processing for generating the translated document DOC_TR from the processing result RES(12) to the processing result RES(max2). The last of the document DOC_O is stored in the block BLK(max). Note that n and max are each an integer greater than 2, and n is an integer less than or equal to max.

In Step S26 and Step S27, the translated document DOC_TR is stored in the information terminal 20.

### [Step S1]

In Step S1, the information terminal 20 receives and transmits the document DOC_O and the metadata DOC_MD.

### [Step S2]

In Step S2, the information processing device 10 receives and stores the document DOC_O and the metadata DOC_MD.

### [Step S3]

In Step S3, the information processing device 10 cuts a character string with a predetermined length from the beginning of the document DOC_O and stores the character string in the block BLK(1).

### [Step S4]

In Step S4, the information processing device 10 generates and transmits the prompt PT(11).

Note that the prompt PT(11) includes the block BLK(1) and the metadata DOC_MD. The prompt PT(11) includes an instruction to translate the block BLK(1) to generate the translation Tr(1). The prompt PT(11) includes an instruction to extract part of the block BLK(1) and to translate the part to generate the translation Tr(Sum(1)).

### [Step S5]

In Step S5, the information processing device 40 receives the prompt PT(11), generates the processing result RES(11) in accordance with the prompt PT(11), and transmits the processing result RES(11).

The processing result RES(11) includes the translation Tr(1) and the translation Tr(Sum(1)).

### [Step S6]

In Step S6, the information processing device 10 receives and stores the processing result RES(11).

### [Step S7]

In Step S7, the information processing device 10 generates and transmits the prompt PT(12).

Note that the prompt PT(12) includes an instruction to compare the block BLK(1) and the translation Tr(1) to generate the correction information CI(1). In addition, the correction information CI(1) includes a mistranslated expression included in the translation Tr(1), the original expression included in the block BLK(1) of the mistranslated expression, and a proofread expression by correction. The prompt PT(12) includes an instruction to compare the block BLK(1) and the translation Tr(1) to generate the proofread translation TrPF(1). In this manner, it is possible to prevent occurrence of a mistranslation between the block BLK(1) and the proofread translation TrPF(1) obtained by proofreading the translation result of the block BLK(1). The prompt PT(12) includes an instruction to compare the block BLK(1) and the translation Tr(Sum(1)) to generate the proofread translation TrPF(Sum(1)). In this manner, it is possible to prevent occurrence of a mistranslation between the block BLK(1) and the proofread translation TrPF (Sum(1)) obtained by proofreading the translation result of the summary of the block BLK(1).

### [Step S8]

In Step S8, the information processing device 40 receives the prompt PT(12), generates the processing result RES(12) in accordance with the prompt PT(12), and transmits the processing result RES(12).

Note that the processing result RES(12) includes the correction information CI(1), the proofread translation TrPF(1), and the proofread translation TrPF(Sum(1)).

### [Step S9]

In Step S9, the information processing device 10 receives the processing result RES(12) and stores the processing result RES(12) following the preceding processing result in sequence.

### [Step S10]

In Step S10, the information processing device 10 cuts a character string with a predetermined length following the block BLK(1) from the document DOC_O and stores the character string in the block BLK(2).

### [Step S11]

In Step S11, the information processing device 10 generates and transmits the prompt PT(21).

Note that the prompt PT(21) includes the proofread translation TrPF(Sum(1)), the block BLK(2), and the metadata DOC_MD. The prompt PT(21) includes an instruction to translate the block BLK(2) by referring to the proofread translation TrPF(Sum(1)) to generate the translation RTr(2). In this manner, it is possible to prevent occurrence of a contradiction between the proofread translation TrPF (Sum(1)) obtained by proofreading the translation of the summary of the block BLK(1) and the translation RTr(2) as the result of the translation of the block BLK(2). The prompt PT(21) includes an instruction to extract part of the block BLK(2) and to translate the part by referring to the proofread translation TrPF(Sum(1)) to generate the translation RTr(Sum(2)). In this manner, it is possible to prevent occurrence of a contradiction between the proofread translation TrPF (Sum(1)) obtained by proofreading the translated summary of the block BLK(1) and the translation RTr (Sum(2)) as the translation result of the summary of the block BLK(2).

### [Step S12]

In Step S12, the information processing device 40 receives the prompt PT(21), generates the processing result RES(21) in accordance with the prompt PT(21), and transmits the processing result RES(21).

Note that the processing result RES(21) includes the translation RTr(2) and the translation RTr(Sum(2)).

### [Step S13]

In Step S13, the information processing device 10 receives the processing result RES(21) and stores the processing result RES(21) following the preceding processing result in sequence.

### [Step S14]

In Step S14, the information processing device 10 generates and transmits the prompt PT(22).

Note that the prompt PT(22) includes an instruction to compare the block BLK(2) and the translation RTr(2) to generate the correction information CI(2). The correction information CI(2) includes a mistranslated expression included in the translation RTr(2), the original expression included in the block BLK(2) of the mistranslated expression, and a proofread expression by correction. The prompt PT(22) includes an instruction to compare the block BLK(2) and the translation RTr(2) to generate the proofread translation TrPF(2). In this manner, it is possible to prevent occurrence of a mistranslation between the block BLK(2) and the proofread translation TrPF(2) that is obtained by proofreading the translation result of the block BLK(2). In addition, the prompt PT(22) includes an instruction to compare the block BLK(2) and the translation RTr(Sum(2)) to generate the proofread translation TrPF(Sum(2)). In this manner, it is possible to prevent occurrence of a mistranslation occurs between the block BLK(2) and the proofread translation TrPF (Sum(2)) that is obtained by proofreading the translation result of the summary of the block BLK(2).

### [Step S15]

In Step S15, the information processing device 40 receives the prompt PT(22), generates the processing result RES(22) in accordance with the prompt PT(22), and transmits the processing result RES(22).

Note that the processing result RES(22) includes the correction information CI(2), the proofread translation TrPF(2), and the proofread translation TrPF(Sum(2)).

### [Step S16]

In Step S16, the information processing device 10 receives the processing result RES(22) and stores the processing result RES(22) following the preceding processing result in sequence.

### [Step S17]

In the case where the last of the document DOC_O is included in the character string cut by the information processing device 10 in Step S17, the last processing result is set as the processing result RES(max2) and the process proceeds to Step S25. For example, in the case where the last of the document DOC_O is included in the block BLK(2), the preceding processing result RES(22) is set as the processing result RES(max2). Similarly, in the case where the last of the document DOC_O is included in the block BLK(n), the preceding processing result RES(n2) is set as the processing result RES(max2). Alternatively, in the case where the last of the document DOC_O is not included in the character string cut by the information processing device 10, the process proceeds to Step S18 until the last of the document DOC_O is included. For example, in the case where the last of the document DOC_O is not included in the block BLK(2), adding 1 to 2, which is the value of an identifier, makes 3 and 3 is used as an identifier of blocks used in Step S18 to Step S24. Similarly, in the case where the last of the document DOC_O is not included in the block BLK(n−1), adding 1 to n−1, which is the value of an identifier, makes n, and n is used as an identifier of blocks used in Step S18 to Step S24. Note that the processing result RES(max2) includes the proofread translation TrPF(max), and the proofread translation TrPF(max) includes the translation of the character string that is cut last.

### [Step S18]

In Step S18, the information processing device 10 cuts a character string with a predetermined length following the preceding block BLK(n−1) from the document DOC_O and stores the character string in the block BLK(n).

### [Step S19]

In Step S19, the information processing device 10 generates and transmits the prompt PT(n1).

Note that the prompt PT(n1) includes the proofread translation TrPF(Sum(n−1)), the block BLK(n), and the metadata DOC_MD, and the proofread translation TrPF(Sum(n−1)) includes the translation of part of the preceding third block BLK(n−1). In addition, the prompt PT(n1) includes an instruction to translate the block BLK(n) by referring to the proofread translation TrPF(Sum(n−1)) to generate the translation RTr(n). In this manner, it is possible to prevent occurrence of a contradiction between the proofread translation TrPF(Sum(1)) obtained by proofreading the translation of the summary of the block BLK(n−1) and the translation RTr(n) as the translation result of the block BLK(n). In addition, the prompt PT(n1) includes an instruction to extract part of the block BLK(n) and to translate the part by referring to the proofread translation TrPF(Sum(n−1)) to generate the translation RTr(Sum(n)). In this manner, it is possible to prevent occurrence of a contradiction between the proofread translation TrPF(Sum(n−1)) obtained by proofreading the translation of the summary of the block BLK(n−1) and the translation RTr (Sum(n)) as the translation result of the summary of the block BLK(n).

### [Step S20]

In Step S20, the information processing device 40 receives the prompt PT(n1), generates the processing result RES(n1) in accordance with the prompt PT(n1), and transmits the processing result RES(n1).

Note that the processing result RES(21) includes the translation Tr(n) and the translation Tr(Sum(n)).

### [Step S21]

In Step S21, the information processing device 10 receives the processing result RES(n1) and stores the processing result RES(n1) following the preceding processing result in sequence.

### [Step S22]

In Step S22, the information processing device 10 generates and transmits the prompt PT(n2).

Note that the prompt PT(n2) includes an instruction to compare the block BLK(n) and the translation RTr(n) to generate the correction information CI(n). The correction information CI(n) includes a mistranslated expression included in the translation Tr(n), the original expression included in the block BLK(n) of the mistranslated expression, and a proofread expression by correction. The prompt PT(n2) includes an instruction to compare the block BLK(n) and the translation Tr(n) to generate a proofread translation TrPF(n). In this manner, it is possible to prevent occurrence of a mistranslation occurs between the block BLK(n) and the proofread translation TrPF(n) obtained by proofreading the translation result of the block BLK(n). The prompt PT(n2) includes an instruction to compare the block BLK(n) and the translation Tr(Sum(n)) to generate a proofread translation TrPF(Sum(n)). In this manner, it is possible to prevent occurrence of a mistranslation between the block BLK(n) and the proofread translation TrPF(Sum(n)) obtained by proofreading the translation result of the summary of the block BLK(n).

### [Step S23]

In Step S23, the information processing device 40 receives the prompt PT(n2), generates the processing result RES(n2) in accordance with the prompt PT(n2), and transmits the processing result RES(n2).

Note that the processing result RES(n2) includes the correction information CI(n), the proofread translation TrPF(n), and the proofread translation TrPF(Sum(n)).

### [Step S24]

In Step S24, the information processing device 10 receives the processing result RES(n2), stores the processing result RES(n2) following the preceding processing result in sequence, and the process proceeds to Step S17.

### [Step S25]

In Step S25, the information processing device 10 extracts the proofread translations in sequence from the processing results stored in sequence, and generates the translated document DOC_TR. Note that the translated document DOC_TR includes the proofread translation TrPF(1) and the proofread translation TrPF(max). For example, in the case where the last of the document DOC_O is included in the block BLK(2), the information processing device 10 stores the processing result RES(12) and the processing result RES(22), the information processing device 10 extracts the translation Tr(1) from the processing result RES(12), extracts the translation Tr(2) from the processing result RES(22), and generates the translated document DOC_TR. In the case where the last of the document DOC_O is included in the block BLK(3), the information processing device 10 stores the processing result RES(12), the processing result RES(22), and the processing result RES(32), and the information processing device 10 extracts the translation Tr(1) from the processing result RES(12), extracts the translation Tr(2) from the processing result RES(22), extracts the translation Tr(3) from the processing result RES(32), and generates the translated document DOC_TR. In the case where the last of the document DOC_O is included in the block BLK(n), the information processing device 10 stores the processing result RES(12), the processing result RES(22), and the processing result RES(32) to the processing result RES(n2), and the information processing device 10 extracts the translation Tr(1) from the processing result RES(12), extracts the translation Tr(2) from the processing result RES(22), extracts the translation Tr(3) to the translation Tr(n) from the processing result RES(32) to the processing result RES(n2), respectively, and generates the translated document DOC_TR. For example, all the extracted translations are combined in sequence to generate the translated document DOC_TR.

### [Step S26]

In Step S26, the information processing device 10 transmits the translated document DOC_TR to the information terminal 20.

### [Step S27]

In Step S27, the information terminal 20 receives and stores the translated document DOC_TR.

In this manner, the document DOC_O can be divided into the block BLK(1) and the block BLK(2) to be translated. For example, the document DOC_O which is too long to be written into one prompt can be translated. The metadata DOC_MD can be used for the translation of the block BLK(1). Furthermore, part of the block BLK(1) can be extracted and then translated into the translation Tr(Sum(1)). In addition, the proofread translation TrPF(1) can be generated by comparing the block BLK(1) and the translation Tr(1). The proofread translation TrPF(Sum((1)) can be generated by comparing the block BLK(1) and the translation Tr(Sum(1)). For the translation of the block BLK(2), the proofread translation TrPF(Sum(1)), the correction information CI(1), and the metadata DOC_MD can be used. Moreover, it is possible to prevent occurrence of a contradiction between the proofread translation TrPF (Sum(1)) obtained by proofreading the translation result of the summary of the block BLK(1) and the proofread translation TrPF(2) obtained by proofreading the translation result of the block BLK(2). In addition, the translated document DOC_TR with few inconsistencies in translation can be generated. In addition, the translated document DOC_TR with consistency can be generated. As a result, a novel information processing method that is highly convenient, useful, or reliable can be provided.

Note that this embodiment can be combined with any of the other embodiments in this specification as appropriate.

This application is based on Japanese Patent Application Serial No. 2023-149985 filed with Japan Patent Office on Sep. 15, 2023, the entire contents of which are hereby incorporated by reference.

What is claimed is:

1. An information processing system comprising:
a first information processing device; and
a second information processing device,
wherein the second information processing device is configured to generate and transmit a first prompt and a second prompt,
wherein the first information processing device is configured to generate a first processing result comprising a first translation and a second translation in accordance with the first prompt and a second processing result comprising a third translation and a fourth translation in accordance with the second prompt,
wherein the first information processing device is configured to transmit the first processing result and the second processing result to the second information processing device,
wherein the second information processing device is configured to receive a document, metadata including information related to an attribute of the document, and a summary,
wherein the second information processing device is configured to cut a first character string with a predetermined length from a beginning of the document and to store the first character string in a first block,
wherein the second information processing device is configured to cut a second character string with a predetermined length starting from the end of the first character string of the document and to store the second character string in a second block,
wherein the first prompt comprises the first block, the metadata, and the summary including part of the first block,
wherein the first prompt comprises an instruction to translate the first block to generate the first translation,
wherein the first prompt comprises an instruction to translate the summary to generate the second translation,
wherein the second prompt comprises the second translation, the second block, and the metadata,
wherein the second prompt comprises an instruction to translate the second block to generate the third translation by referring to the second translation,
wherein the second prompt comprises an instruction to extract part of the second block and to translate the part by referring to the second translation to generate the fourth translation,
wherein the second information processing device is configured to extract the first translation and the third translation from the first processing result and the second processing result, respectively, and
wherein the second information processing device is configured to generate a translated document using the first translation and the third translation.

2. An information processing method comprising:
a first step of receiving and dividing a document into a plurality of blocks;
a second step of transmitting a first prompt to a first information processing device;
a third step of receiving a first translation generated by the first information processing device in accordance with the first prompt; and
a fourth step of transmitting a second prompt to the first information processing device,
wherein the first prompt comprises a text of an N-th block of the plurality of blocks and a first instruction to generate the first translation of the text of the N-th block,
wherein the second prompt comprises at least part of the first translation of the text of the N-th block, a text of an N+1-th block, and a second instruction to generate a second translation of the text of the N+1-th block, and
wherein N is an integer greater than 0.

3. An information processing method comprising:
a first step in which an information terminal receives and transmits a document, metadata, and a summary;
a second step in which a first information processing device receives and stores the document, the metadata, and the summary;
a third step in which the first information processing device cuts a first character string with a predetermined length from a beginning of the document and stores the first character string in a first block;
a fourth step in which the first information processing device generates and transmits a first prompt comprising the first block, the metadata, and the summary to a second information processing device;
a fifth step in which the second information processing device generates a first processing result in accordance with the first prompt and transmits the first processing result to the first information processing device to store the first processing result;
a sixth step in which the first information processing device cuts a second character string with a predetermined length starting from the end of the first character string of the document and stores the second character string in a second block; and
a seventh step in which the first information processing device generates and transmits a second prompt,
wherein the summary comprises part of the first block,
wherein the first prompt comprises an instruction to translate the first block to generate a first translation,
wherein the first prompt comprises an instruction to translate the summary to generate a second translation,
wherein the first processing result comprises the first translation and the second translation,
wherein the second prompt comprises the second translation, the second block, and the metadata,
wherein the second prompt comprises an instruction to translate the second block by referring to the second translation to generate a third translation, and
wherein the second prompt comprises an instruction to extract part of the second block and to translate the part by referring to the second translation to generate a fourth translation.

4. The information processing method according to claim 3, further comprising:
an eighth step in which the second information processing device receives the second prompt, generates a second processing result in accordance with the second prompt, and transmits the second processing result comprising the third translation and the fourth translation;
a ninth step in which the first information processing device receives the second processing result and stores the second processing result;
a tenth step in which a character string cut by the first information processing device including the last character of the document is set as a third processing result comprising a fifth translation;
an eleventh step in which the first information processing device extracts the first to fifth translations in sequence and generates a translated document;
a twelfth step in which the first information processing device transmits the translated document to the information terminal; and
a thirteenth step in which the information terminal receives and stores the translated document,
wherein the third processing result is the last processing result.
